(19) United States
(12) Patent Application Publication
(10) Pub. No.: US 2025/0055765 A1
(43) Pub. Date: Feb. 13, 2025

(54) SYSTEMS AND METHODS TO CONTROL AIML MODEL RE-TRAINING IN COMMUNICATION NETWORKS

(71) Applicant: Telefonaktiebolaget LM Ericsson (publ), Stockholm (SE)

(72) Inventors: Pablo Soldati, Solna (SE); Luca Lunardi, Genoa (IT); Philipp Bruhn, Aachen (DE); Henrik Rydén, Stockholm (SE); Angelo Centonza, Granada (ES)

(21) Appl. No.: 18/719,048

(22) PCT Filed: Dec. 21, 2022
(86) PCT No.: PCT/EP2022/087253

§ 371 Date: Jun. 12, 2024

Related U.S. Application Data
(60) Provisional application No. 63/292,080, filed on Dec. 21, 2021.

(51) Int. Cl. H04L 41/16; H04W 24/10

(52) U.S. Cl. CPC H04L 41/16; H04W 24/10

(57) ABSTRACT

Systems and methods to control AIML model re-training in communication networks are provided. In some embodiments, a method performed by a first network node includes transmitting a FIRST MESSAGE towards a second network node, including a model; and receiving a SECOND MESSAGE transmitted by the second network node, including an indication that the second network node has re-trained or modified the model. Some embodiments propose a method for a first network node to control whether and how an AIML model, possibly trained by a first network (or by another node), provided to a second network node could or should be re-trained or modified by the second network node. A modification of the model, such as in its structure, would implicitly require a model re-training, whereas a model re-training (or updating) does not imply a modification of the model itself, but just an optimization of the model parameters.

### RELATED APPLICATIONS

This application claims the benefit of provisional patent application Ser. No. 63/292,080, filed Dec. 21, 2021, the disclosure of which is hereby incorporated herein by reference in its entirety.

### TECHNICAL FIELD

The present disclosure relates generally to training and re-training models.

### BACKGROUND

A Study Item (SI) “Enhancement for Data Collection for NR and EN-DC” is defined in 3GPP RP-201620.

The study item aims to study the functional framework for RAN intelligence enabled by further enhancement of data collection through use cases, examples etc. and identify the potential standardization impacts on current NG-RAN nodes and interfaces.

The detailed objectives of the SI are listed as follows:

Study high level principles for RAN intelligence enabled by AI, the functional framework (e.g., the AI functionality and the input/output of the component for AI enabled optimization) and identify the benefits of AI enabled NG-RAN through possible use cases e.g., energy saving, load balancing, mobility management, coverage optimization, etc.:
a) Study standardization impacts for the identified use cases including: the data that may be needed by an AI function as input and data that may be produced by an AI function as output, which is interpretable for multi-vendor support.
b) Study standardization impacts on the node or function in current NG-RAN architecture to receive/provide the input/output data.
c) Study standardization impacts on the network interface(s) to convey the input/output data among network nodes or AI functions.

As part of the SI work, a Text Proposal (TP) has been agreed for 3GPP Technical Report (TR) 37.817 in R3-212978, as reported below.

The following high-level principle should be applied for AI-enable RAN intelligence have been agreed:
The detailed AI/ML algorithms and models for use cases are out of RAN3 scope.
The study focuses on AI/ML functionality and corresponding types of inputs/outputs.
The input/output and the location of Model inference function should be studied case by case.
RAN3 should focus on the analysis of data needed at the Model training function from external functions, while the aspects of how the Model training function uses inputs to train a model are out of RAN3 scope.
The Model training and Model inference functions should be able to request, if needed, specific information to be used to train or execute the AI/ML algorithm and to avoid reception of unnecessary information. The nature of such information depends on the use case and on the algorithm.
The Model inference function should signal the outputs of the model only to nodes that have explicitly requested them (e.g., via subscription), or nodes that are subject to actions based on the output from model inference. NG-RAN is prioritized; EN-DC is included in the scope. FFS on whether MR-DC should be down-prioritized.
A general framework and workflow for AI/ML optimization should be defined and captured in the TR. The generalized workflow should not prevent to “think beyond” the workflow if the use case requires so.

The Functional Framework for RAN Intelligence comprised in R3-212978 is shown in FIG. 4.2-1 of the same TP, reported below. This is included herein as FIG. 1.

The current definitions of the individual blocks and signals represented in the Function Framework are detailed below.
Data Collection is a function that provides input data to Model training and Model inference functions. AI/ML algorithm specific pre-processing of data is not carried out in the Data Collection function. Examples of input data may include measurements from UEs or different network entities, performance feedback, AI/ML model output.
   Training Data: information needed for the AI/ML model training function.
   Inference Data: information needed as an input for the Model inference function to provide a corresponding output.
Model Training is a function that performs the training of the ML model. The Model training function is also responsible for data preparation (e.g., data pre-processing and cleaning, formatting, and transformation of raw data), if required.
Model Inference is a function that provides AI/ML model inference output (e.g., predictions or decisions). The Model inference function is also responsible for data preparation (e.g., data pre-processing and cleaning, formatting, and transformation of raw data), if required.
Actor is a function that receives the output from the Model inference function and triggers or performs corresponding actions. The Actor may trigger actions directed to other entities or to itself.
Feedback: Information that may be needed to derive training or inference data or performance feedback.

The following text is presented at RAN3 #113-e in R3-213468 in relation to an ML model validation:

Validating the ML model is important to ensure its accuracy. Basically, when the model is trained, validating the model with different set of data (e.g., different from training data) provides an opportunity to further improve the model quality, which further avoids making wrong decisions taken by the machine in the real-life prediction.

In this case, besides training data provided to “Model Training” function and inference data provided to “Model Inference” function, “Data Collection” should also provide validation data to “Model Training”, so that the accuracy of the trained model can be guaranteed.

Proposal 13: “Data Collection” function should also provide validation data to “Model Training” function for ML model validation.

Proposal 14: “Model Training” should also perform model validation based on the validation data set received from “Data Collection” to further improve model accuracy.

During RAN3-114e a discussion on “online training” occurred. It was discussed that once the Model Training function deploys a model to the node hosting the Model Inference function, it might be possible for such node to further train the model. This is reflected in a note added to TR37.817, which states the following:

Note: gNB is also allowed to continue model training based on AI/ML model trained in the OAM.

### Model Complexity Reduction

Pruning is a data compression technique in machine learning and search algorithms that reduces the size of ML models. One example is decision trees, where one can by removing sections of the tree that are non-critical and redundant to classify instances reduce the tree size. One can for example use pruning on the experienced inference data of a decision tree model to remove branches that are not being used (modify the model). The subtree that is removed is chosen for example based on the frequency in ending up in said node. In general, the modification of a model can be done in a similar setup for other models, such as nearest neighbor approach (remove some data samples), or ensemble-based learners (remove one or more weak learners).

There currently exist certain challenges. Improved systems and methods for AIML model training are needed.

### SUMMARY

Systems and methods to control AIML model re-training in communication networks are provided. In some embodiments, a method performed by a first network node includes transmitting a FIRST MESSAGE towards a second network node, the FIRST MESSAGE comprising a model; and receiving a SECOND MESSAGE transmitted by the second network node, the SECOND MESSAGE including an indication that the second network node has re-trained or modified, the model transmitted by the first network node.

Some embodiments of the present disclosure propose a method for a first network node to control whether and how an AIML model, possibly trained by a first network (or by another node), provided to a second network node could or should be re-trained or modified by the second network node. It should be noted that a modification of the model, such as in its structure, would implicitly require a model re-training, whereas a model re-training (or updating) does not imply a modification of the model itself, but just an optimization of the model parameters.

Some embodiments of the present disclosure further disclose methods for the first network node to provide an AIML model to a second network node and to be notified when, whether, and how an AIML model has been re-trained or modified (by the second network node or by a third network node).

Furthermore, some embodiments of the present disclosure include solutions for the first network node to provide to the second network node information indicating whether an AIML model provided by the first network node to the second network node can be re-trained or modified (by the second network node or by a third network node). Additionally, the method provides solutions for the first network node to further provide recommendations or instructions to re-train or modify the AIML model provided to the second network node, as well as solutions to request the second network node to provide feedback information related to whether and how the model provided by the first network node has been re-trained and/or modified.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the Functional Framework for RAN Intelligence according to some embodiments of the present disclosure;

FIG. 2 illustrates one example of a cellular communications system in which embodiments of the present disclosure may be implemented, according to some embodiments of the present disclosure;

FIG. 3 illustrates a wireless communication system represented as a 5G network architecture composed of core Network Functions (NFs), where interaction between any two NFs is represented by a point-to-point reference point/interface, according to some embodiments of the present disclosure;

FIG. 4 illustrates a 5G network architecture using service-based interfaces between the NFs in the CP, instead of the point-to-point reference points/interfaces used in the 5G network architecture of FIG. 3, according to some other embodiments of the present disclosure;

FIG. 5 is an illustration of the method wherein a first network node provides an AIML model to a second network node together with one or more information related to whether the AIML model can be re-trained or modified by the second network node, according to some other embodiments of the present disclosure;

FIG. 6 is an illustration of an embodiment of the method wherein the first network node further provides to the second network node one or more information related to whether the AIML model can be re-trained or modified by the second network node, according to some other embodiments of the present disclosure;

FIG. 7A is an illustration of an embodiment of the method wherein the first network node further receives a THIRD MESSSAGE from the second network node indicating that a model provided by the first network node to the second network node has been re-trained or modified by the second network node, according to some other embodiments of the present disclosure;

FIG. 7B illustrates a method performed by the second network node with additional features, according to some other embodiments of the present disclosure;

FIG. 8 illustrates an example of the method wherein the first network node is an OAM or a SMO node, while the second network node could be a RAN node, according to some other embodiments of the present disclosure;

FIG. 9 is an illustration of a non-limiting example of the method wherein the first network node is a gNB-CU-CP, and the second network node is a gNB-DU, according to some other embodiments of the present disclosure;

FIG. 10 illustrates a non-limiting example of how the method can be mapped to the AIML functional framework for the NG-RAN and E-UTRAN system defined by 3GPP, according to some other embodiments of the present disclosure;

FIG. 11A illustrates a non-limiting example of how the method can be mapped to the AIML functional framework for the NG-RAN and E-UTRAN system defined by RAN3 3GPP, according to some other embodiments of the present disclosure;

FIG. 11B illustrates an example of a scenario where the first network node is an Operation And Maintenance (OAM) node, while the second and third network nodes belong to an NG-RAN node with split architecture, such as a gNB-CU-CP and a gNB-DU, respectively, according to some other embodiments of the present disclosure;

FIG. 12 is a schematic block diagram of a radio access node according to some embodiments of the present disclosure;

FIG. 13 is a schematic block diagram that illustrates a virtualized embodiment of the radio access node according to some embodiments of the present disclosure;

FIG. 14 is a schematic block diagram of the radio access node according to some other embodiments of the present disclosure;

FIG. 15 is a schematic block diagram of a wireless communication device according to some embodiments of the present disclosure;

FIG. 16 is a schematic block diagram of the wireless communication device according to some other embodiments of the present disclosure;

FIG. 17 illustrates a communication system includes a telecommunication network, such as a 3GPP-type cellular network, which comprises an access network, such as a RAN, and a core network according to some other embodiments of the present disclosure;

FIG. 18 illustrates, in a communication system, a host computer comprises hardware including a communication interface configured to set up and maintain a wired or wireless connection with an interface of a different communication device of the communication system, according to some other embodiments of the present disclosure;

FIG. 19 is a flowchart illustrating a method implemented in a communication system, according to some other embodiments of the present disclosure;

FIG. 20 is a flowchart illustrating a method implemented in a communication system, according to some other embodiments of the present disclosure;

FIG. 21 is a flowchart illustrating a method implemented in a communication system, according to some other embodiments of the present disclosure; and

FIG. 22 is a flowchart illustrating a method implemented in a communication system, according to some other embodiments of the present disclosure.

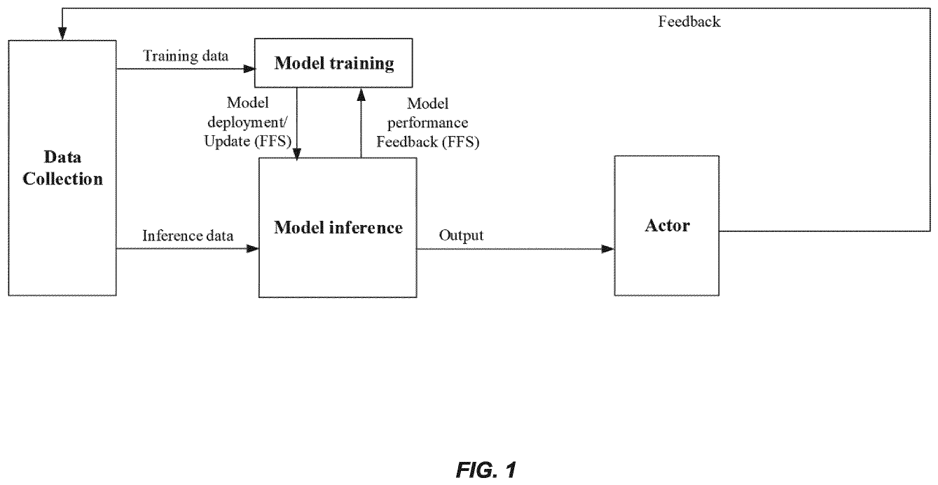

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)—only TP. TPs can include base station (eNB) antennas, Remote Radio Heads (RRHs), a remote antenna of a base station, an antenna of a PRS—only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

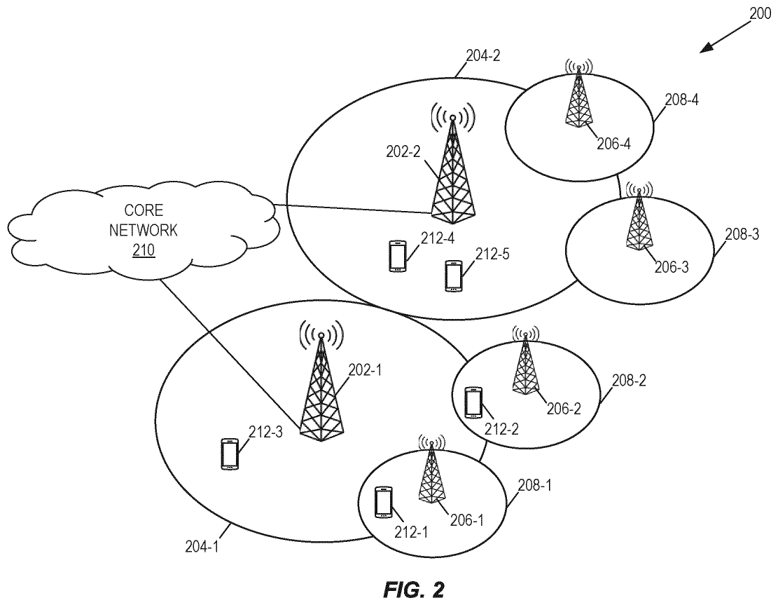

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC). In this example, the RAN includes base stations 202-1 and 202-2, which in the 5GS include NR base stations (gNBs) and optionally next generation eNBs (ng-eNBs) (e.g., LTE RAN nodes connected to the 5GC), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

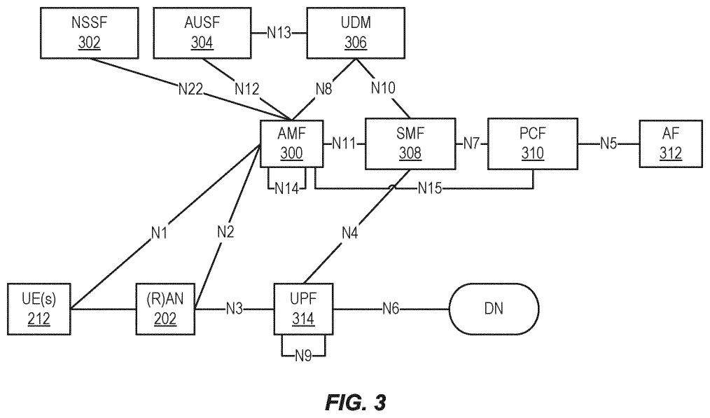

FIG. 3 illustrates a wireless communication system represented as a 5G network architecture composed of core Network Functions (NFs), where interaction between any two NFs is represented by a point to point reference point/interface. FIG. 3 can be viewed as one particular implementation of the system 200 of FIG. 2.

Seen from the access side the 5G network architecture shown in FIG. 3 comprises a plurality of UEs 212 connected to either a RAN 202 or an Access Network (AN) as well as an AMF 300. Typically, the R(AN) 202 comprises base stations, e.g., such as eNBs or gNBs or similar. Seen from the core network side, the 5GC NFs shown in FIG. 3 include a NSSF 302, an AUSF 304, a UDM 306, the AMF 300, a SMF 308, a PCF 310, and an Application Function (AF) 312.

Reference point representations of the 5G network architecture are used to develop detailed call flows in the normative standardization. The N1 reference point is defined to carry signaling between the UE 212 and AMF 300. The reference points for connecting between the AN 202 and AMF 300 and between the AN 202 and UPF 314 are defined as N2 and N3, respectively. There is a reference point, N11, between the AMF 300 and SMF 308, which implies that the SMF 308 is at least partly controlled by the AMF 300. N4 is used by the SMF 308 and UPF 314 so that the UPF 314 can be set using the control signal generated by the SMF 308, and the UPF 314 can report its state to the SMF 308. N9 is the reference point for the connection between different UPFs 314, and N14 is the reference point connecting between different AMFs 300, respectively. N15 and N7 are defined since the PCF 310 applies policy to the AMF 300 and SMF 308, respectively. N12 is required for the AMF 300 to perform authentication of the UE 212. N8 and N10 are defined because the subscription data of the UE 212 is required for the AMF 300 and SMF 308.

The 5GC network aims at separating UP and CP. The UP carries user traffic while the CP carries signaling in the network. In FIG. 3, the UPF 314 is in the UP and all other NFs, i.e., the AMF 300, SMF 308, PCF 310, AF 312, NSSF 302, AUSF 304, and UDM 306, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 300 and SMF 308 are independent functions in the CP. Separated AMF 300 and SMF 308 allow independent evolution and scaling. Other CP functions like the PCF 310 and AUSF 304 can be separated as shown in FIG. 3. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

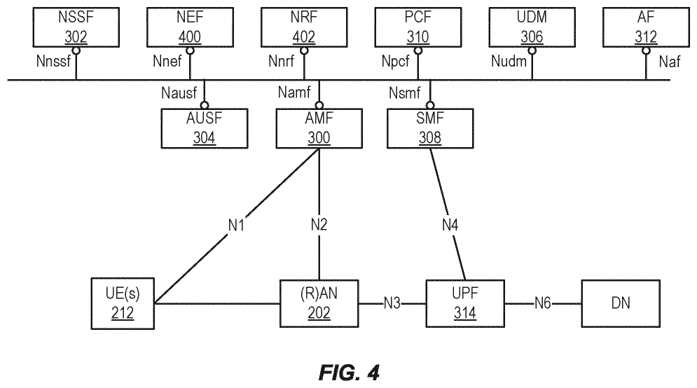

FIG. 4 illustrates a 5G network architecture using service-based interfaces between the NFs in the CP, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4, the service-based interfaces are indicated by the letter “N” followed by the name of the NF, e.g., Namf for the service-based interface of the AMF 300 and Nsmf for the service-based interface of the SMF 308, etc. The NEF 400 and the NRF 402 in FIG. 4 are not shown in FIG. 3 discussed above. However, it should be clarified that all NFs depicted in FIG. 3 can interact with the NEF 400 and the NRF 402 of FIG. 4 as necessary, though not explicitly indicated in FIG. 3.

Some properties of the NFs shown in FIGS. 3 and 4 may be described in the following manner. The AMF 300 provides UE-based authentication, authorization, mobility management, etc. A UE 212 even using multiple access technologies is basically connected to a single AMF 300 because the AMF 300 is independent of the access technologies. The SMF 308 is responsible for session management and allocates Internet Protocol (IP) addresses to UEs. It also selects and controls the UPF 314 for data transfer. If a UE 212 has multiple sessions, different SMFs 308 may be allocated to each session to manage them individually and possibly provide different functionalities per session. The AF 312 provides information on the packet flow to the PCF 310 responsible for policy control in order to support QoS. Based on the information, the PCF 310 determines policies about mobility and session management to make the AMF 300 and SMF 308 operate properly. The AUSF 304 supports authentication function for UEs or similar and thus stores data for authentication of UEs or similar while the UDM 306 stores subscription data of the UE 212. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

For the proposed solution, the following is considered:

A network node can be a RAN node, an OAM, a Core Network node, an OAM, an SMO, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB.

The terms model training, model optimizing, model optimization, and model updating are herein used interchangeably with the same meaning unless explicitly specified otherwise.

The terms model changing, modify or similar are herein used interchangeably with the same meaning unless explicitly specified otherwise. In particular, they refer to the fact that the type, structure, parameters, connectivity of an AIML model may have changed compared to a previous format/configuration of the AIML model.

The terms AI/ML model, AI/ML policy, AI/ML algorithm, as well the terms, model, policy or algorithm are herein used interchangeably with the same meaning unless explicitly specified otherwise.

References to “network nodes” herein should be understood such that a network node may be a physical node or a function or logical entity of any kind, e.g., a software entity implemented in a data center or a cloud, e.g., using one or more virtual machines, and two network nodes may well be implemented as logical software entities in the same data center or cloud.

The methods provided with the present disclosure are independent with respect to specific AI/ML model types or learning problems/setting (e.g., supervised learning, unsupervised learning, reinforcement learning, hybrid learning, centralized learning, federated learning, distributed learning, . . . )

Non limiting examples of AI/ML algorithms may include supervised learning algorithms, deep learning algorithms, reinforcement learning type of algorithms (such as DQN, A2C, A3C, etc.), contextual multi-armed bandit algorithms, autoregression algorithms, etc., or combinations thereof.

Such algorithms may exploit functional approximation models, hereafter referred to as AI/ML models, such as neural networks (e.g., feedforward neural networks, deep neural networks, recurrent neural networks, convolutional neural networks, etc.).

There currently exist certain challenge(s). With communication networks, such as radio access network (RAN), using AIML technology it is possible that an AIML model can be trained by a first network node could be re-trained and/or modified by other network nodes. This could be the case, for instance, when a control node is used to train and provide AIML model to other network nodes (such as radio access nodes) which could in turn re-train or modify the AIML model to better fit or specialize to the local environment experienced by such network nodes.

When local network node re-train or modify an AIML model previously trained by a first network node, it is possible that the first network node that had originally crated/trained the AIML model will lose control or knowledge of how the AIML model has been re-trained or modified by other entities. In turn, the first network node would not be able to assess how the AIML model is performing when used by other network nodes, nor be able to understand the feedback that other networks nodes could provide in relation to the AIML model. Additionally, when the first network node provides the same AIML model to multiple network nodes, it is possible that by re-training such AIML model at different network nodes, multiple variants of the original AIML node will be created. In this case, any feedback provided to the first network node by other network nodes would be associated to different version of the original AIML model which are unknown to the first network node. As such, the first network node may not distinguish feedback information that belong to different versions of the AIML model, nor would be able to determine which feedback information is more relevant and what actions are necessary to optimize the original AIML model. Thereby, the system performance could be degraded by an uncontrolled proliferation of different variants of an AIML model.

If it is possible for the node (e.g., a RAN node or a part of the RAN node, e.g., a gNB-CU or a gNB-DU) hosting the Model Inference function to continue training an AI/ML model that is received from the Model Inference function, then there is a problem of coordination between the Model Training function and the node hosting the Model Inference function. Without such coordination the following issues might occur:
It is not possible for the Model Training function to know to which AI/ML model the received feedback corresponds to.
It is not possible for the Model Training function to know whether the node hosting the Model Inference function is using a model that is updated with respect to the model trained by the Model Training function. Hence, if the Model Training function decides to update its own model and to deploy it to the node (e.g., a RAN node or a part of a RAN node, such as a gNB-CU) hosting the Model Inference function, the model deployed might be less effective than the model further trained by the node hosting the Model Inference function.
If the node hosting the Model Inference function has modified the AI/ML model received by the Model Training function to better suite its capabilities or its use cases, the Model Training function would not know about it. This would prevent the Model Training function to train, in the future, models that can fit the node's capabilities and use case requirements.

Certain aspects of the present disclosure and their embodiments may provide solutions to the aforementioned or other challenges. Some embodiments of the present disclosure propose a method for a first network node to control whether and how an AIML model, possibly trained by a first network (or by another node), provided to a second network node could or should be re-trained or modified by the second network node. It should be noted that a modification of the model, such as in its structure, would implicitly require a model re-training, whereas a model re-training (or updating) does not imply a modification of the model itself, but just an optimization of the model parameters.

Some embodiments of the present disclosure further disclose methods for the first network node to provide an AIML model to a second network node and to be notified when, whether, and how an AIML model has been re-trained or modified (by the second network node or by a third network node).

Furthermore, some embodiments of the present disclosure include solutions for the first network node to provide to the second network node information indicating whether an AIML model provided by the first network node to the second network node can be re-trained or modified (by the second network node or by a third network node). Additionally, the method provides solutions for the first network node to further provide recommendations or instructions to re-train or modify the AIML model provided to the second network node, as well as solutions to request the second network node to provide feedback information related to whether and how the model provided by the first network node has been re-trained and/or modified.

There are, proposed herein, various embodiments which address one or more of the issues disclosed herein.

### Method Executed by a First Network Node (Training Function)

Some embodiments of the present disclosure include a method executed by a first network node to control the re-training of an AIML model in a second network node, in a radio communication network comprising the steps of:
Transmitting a FIRST MESSAGE to the second network node comprising an AIML model
Receiving a SECOND MESSAGE from the second network node comprising an indication that the second network node has re-trained or modified, an AIML model received from the first network node.

Therefore, the SECOND MESSAGE may provide a notification to the first network node that the second network node has re-trained or modified an AIML model provided by the first network node.

In one embodiment, the first network node may additionally
Transmitting within the FIRST MESSAGE or with a THIRD MESSAGE, further information associated to the AIML model comprising one or more of
   An identity or an identifier of an AIML model and/or an identifier of a specific version or vendor or type of the AIML model to which the transmitted information is applicable to or associated to.
   An indication that the AIML model cannot be re-trained or modified
   An indication that the AIML model can be re-trained or modified
   An indication that AIML model re-training or modification is suggested or recommended type

The information provided with the FIRST MESSAGE or with a THIRD MESSAGE may further include an indication of at least one network node (e.g., second network node or a third network node) to which the provided indications are associated to. For instance, an indication of at least a network node which could re-train or modify the AIML model.

In one embodiment, when the first network node indicates to the second network node that the AIML model provided by the first network node can be re-trained or modified, the first network node may further transmit to the second network node, either with the FIRST MESSAGE or with the THIRD MESSAGE, one or more information related to retraining or modifying the AIML model, which may comprise one or more of:
[1] One or more conditions or events to be fulfilled for retraining the AI/ML model
[2] One or more instructions or policies or recommendations related to re-training the AIML model
[3] One or more instructions or policies or recommendations related to modifying the AIML model
[4] A request to transmit to the first network node an indication that the second network node has updated, re-trained and/or modified an AIML model provided by the first network node. The first network node may further request information associated to the changes/modifications or updates done by the second network node to the AIML model. In some embodiments, this request is either within the FIRST MESSAGE, within the SECOND MESSAGE, or within another message. The first network node may further request assistance data such as the input data or data ranges used (or excluded) by the second network node to retrain/modify the model, the inputs and outputs generated by the second network node when using the re-trained/modified model. The latter information allows the first network node to deduce how the new model developed by the second network node is performing.
[5] One or more conditions or events to be fulfilled for transmitting to the first network node an indication that the second network node has updated, re-trained and/or modified an AIML model provided by the first network node, such as changes in the environment where the model is applied (e.g., if the model is used for predictions of radio parameters/conditions, the event could consist of changes of the radio planning, changes of the radio conditions)
[6] One or more conditions related to use case(s) or time scale(s) for which re-training or modification of AIML model is possible or suggested or recommended.

Each of the items [1]-[6] is further described in individual embodiments herein.

In one embodiment, the first network node can be an Operation and management (OAM) node, or a service and management orchestration (SMO) node, while the second network node could be a RAN node, such as NG-RAN node, or a function of a RAN node (gNB, gNB-CU-CP, . . . ), a network node realizing at least in part a Non-Real Time Radio Intelligent Controller (Non-Real Time RIC), a network node realizing at least in part a Near-Real Time RIC, a Core Network node, a Cloud-based centralized training node.

### Method Executed by a Second Network Node

Some embodiments of the present disclosure include a method executed by a second network node to control the re-training or modification of an AIML model received from a first network node, in a radio communication network comprising the steps of:
Receiving a FIRST MESSAGE from the first network node comprising an AIML model
Transmitting a SECOND MESSAGE to the first network node comprising an indication that the second network node has re-trained or modified the AIML model received from the first network node.

Therefore, the SECOND MESSAGE may provide a notification to the first network node that the second network node has re-trained or modified an AIML model provided by the first network node.

In one embodiment, the second network node may additionally
Receive within the FIRST MESSAGE or with a THIRD MESSAGE, one or more information associated to the AIML indicating
   That the AIML model cannot be re-trained or modified
   That the AIML model can be re-trained or modified
   That AIML model re-training or modification is suggested or recommended

In additional embodiments, the second network node may additionally transmit either via the SECOND MESSAGE or via a FOURTH MESSAGE, a feedback report related to how an AIML model provided by the first network node to the second network node has been re-trained or modified by the second network node. The feedback report provided by the second network node in association to re-training or modifying an AIML model may comprise one or more information elements in the group of:
One or more information related to at least a condition or event that triggered the re-training or the modification of the AIML model (either at the second network node or in a third network node).
One or more information related to how the AIML model has been re-trained
One or more information related to how the AIML model has been modified
Information about the type of training data used, e.g., Data definition and semantics, range of training data values (e.g., Training data used within range [x, . . . ,y]), amount of data used (e.g., X million training data samples used for training), data used per data value range (e.g., X million training data samples within range [x, . . . ,y] used for training)
Instances of the outputs derived with the retrained/modified model and associated sample inputs
An indication that the model has been augmented or reduced. Such indication may either be an enumerated field with values indicating “Augmented model” or “reduced model”, or it may be a more detailed indication of how the model has been augmented/reduced, for example, in the case the model consists of a neural network, possible indications could be “Neural network augmented to X number of layers”, “Neural network reduced to X number of layers”
An indication that the model has been modified and that the type of AIML model has been changed. For example, the indication could consist of different types of model types such as Linear Regression, Neural Network, Logistic Regression, Decision Trees, etc.
The retrained/modified model. Such retrained/modified model may be taken into account by the first network node for further development. Alternatively, the retrained/modified model may be considered by the first network node for comparison with the models trained by the first network node. Such comparison may lead to a better understanding of how to best train a model that fits the requirements and use cases at the second network node.
An identity or an identifier of an AIML model to which the transmitted information is applicable to or associated to.
An identifier of a specific version or vendor of the AIML model

In one embodiment the second network node may host several different models, some of them received from the first network node and some other derived by means of re-training/modification at the second network node. In some embodiments, some can be implemented by default at the node and then potentially re-trained and/or modified by respective node. The second network node is able to choose which model to use to infer information regarding the use cases and conditions the second node needs to analyze.

Certain embodiments may provide one or more of the following technical advantage(s). Some embodiments of the present disclosure include a method for a first network node to control whether and how an AIML model (possibly trained by the first network node) provided to a second network node could or should be re-trained or modified (by the second network node or by a third network node).

Another core aspect of the method disclosed herein is a solution for the first network node to be notified when, whether, and how an AIML model provided by the first network node to a second network node has been re-trained or modified (by the second network node or by a third network node).

One of the advantages of the proposed solution is to enable a first network node responsible to train and provide AIML models to a second network node, to maintain control over possible re-training, modifications, or updates done to the AIML model by the second network node, for instance by network nodes where the AIML model is deployed and used for inference.

Another advantage of the method is to enable the first network node to determine whether feedback information received from the second network node in association to the AIML model, such as performance feedback information, training data samples, etc., are still relevant to re-train the AIML model.

Another advantage of the methods is to enable a clear split in the training processes performed by the Model Training function and the re-training processes carried out by a second network node hosting the Model Inference function, while maintaining awareness at the Model Training function that re-training is occurring. The latter allows the Model Training function to adapt its training processes also taking into account that a retraining model is available at the node hosting the Model Inference function.

Enabling a second node to modify or retrain the model can imply simplified model(s) and hence less memory and computational resources. For example, a second node can prune the model, for example the decision tree based on new observed data. In some embodiments, allowance of retraining enables the first node to add new information to the model, in a simple example, it could comprise a new sample for the nearest neighbor regressor/classifier.

It enables better root cause analysis in a first node in case something goes wrong in the second node.

Examples of reinforcement learning algorithms may include deep reinforcement learning (such as deep Q-network (DQN), proximal policy optimization (PPO), double Q-learning), actor-critic algorithms (such as Advantage actor-critic algorithms, e.g., A2C or A3C, actor-critic with experience replay, etc.), policy gradient algorithms, off-policy learning algorithms, etc.

As used herein, a first network node and a second network node can be any of the radio access nodes described herein, core network nodes described herein, or any other suitable nodes. Some embodiments of the present disclosure include a method executed by a first network node to control the re-training, modification of an AIML model in a second network node, in a radio communication network comprising the steps of:
Transmitting a FIRST MESSAGE to the second network node comprising an AIML model,
Receiving a SECOND MESSAGE from the second network node comprising an indication that the second network node has re-trained or modified an AIML model received from the first network node

Therefore, the SECOND MESSAGE may provide a notification to the first network node that the second network node has re-trained or modified an AIML model provided by the first network node.

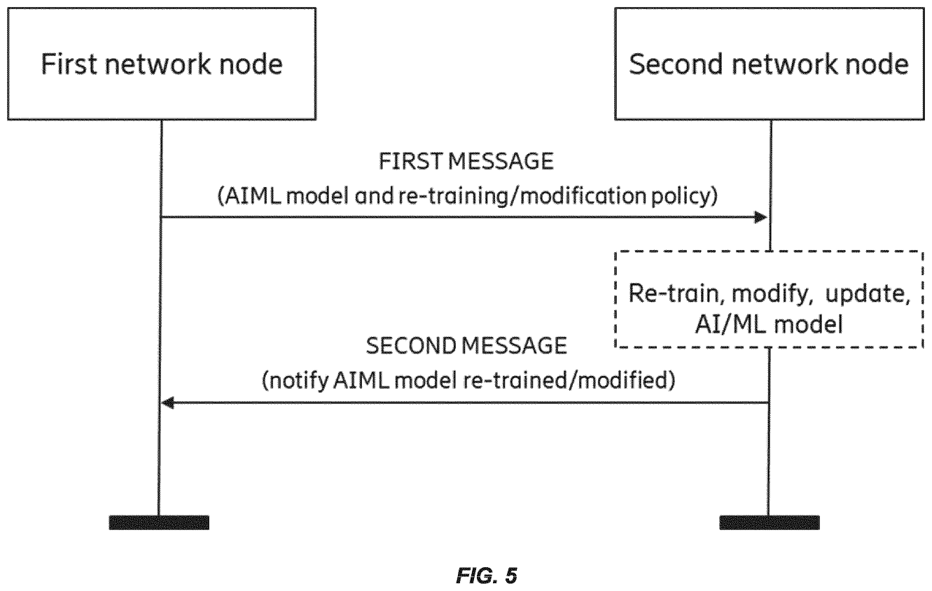

FIG. 5 is an illustration of the method wherein a first network node provides an AIML model to a second network node together with one or more information related to whether the AIML model can be re-trained or modified by the second network node. The dashed box indicates that the steps of re-train, modify, or update could be optional.

In an alternative embodiment, the SECOND MESSAGE may request the first network node to indicate whether the AIML model provided to the second network node can be re-trained or modified (by the second network node or by a third network node).

Some embodiments do not assume or imply a specific way or format in which the AIML model is expressed and transferred between a first network node and a second network node. Non-limiting examples may include:
a. Software package (e.g., executable) embedding the model and providing one or more interfaces to interact with the model (e.g., to query the model)
   i. Docker is one such example, where the Docker containers contain all components which are needed for the ML model, including code, libraries, runtimes, and system tools. Containers can therefore be used to ensure that the second node don't risk of missing or having incompatible libraries leading to errors. However, since the container supports more than only the model parameters itself, it is therefore larger in size.
b. Source code that implements the model and can be executed directly or compiled to create a software package (e.g., executable)
c. Serialized files associated to a specific AI/ML framework (e.g., scikit-learn, PyTorch, or TensorFlow)
d. Serialized files in open standard, interoperable formats (e.g., Open Neural Network exchange (ONNX))
e. Specification of model type or algorithm (e.g., decision trees, random forest, ensemble based, nearest neighbor, feed-forward neural network, convolutional neural network, recurrent neural network, graph neural networks, etc.), hyperparameters, and model parameters (i.e., set of weights or tensors)

### Embodiments Related to First Message and Third Message

In one embodiment, the first network node may additionally:
a. Transmit within the FIRST MESSAGE or with a THIRD MESSAGE, further information associated to the AIML indicating one or more in the group of:
   i. An identity or an identifier of an AIML model and/or an identifier of a specific version or vendor of the AIML model to which the transmitted information is applicable to or associated to.
   ii. An indication that the AIML model cannot be re-trained or modified
   iii. An indication that the AIML model can be re-trained or modified
   iv. An indication that AIML model re-training or modification is suggested or recommended (e.g., for a particular use case or to fulfil some specific time scale requirements)

The information provided with the FIRST MESSAGE or with a THIRD MESSAGE may further include an indication of at least one network node (e.g., second network node or a third network node) to which the provided indications are associated to. For instance, an indication of at least a network node which could re-train or modify the AIML model.

In one embodiment of the method, the first network node transmits a THIRD MESSAGE in response to a SECOND MESSAGE received from the second network node, wherein:
a. The SECOND MESSAGE comprises a request to the first network node from the second network node to indicate whether an AIML model provided by the first network node to the second network node can be re-trained or modified (by the second network node or by a third network node).
b. The THIRD MESSAGE comprises one or more information associated to the AIML indicating one or more of:
   i. That the AIML model cannot be re-trained or modified
   ii. That the AIML model can be re-trained or modified
   iii. That AIML model re-training or modification is suggested or recommended (e.g., for a particular use case or to fulfil some specific time scale requirements)

In one example, the AIML model may be associated with an identifier or an identity. In this example, the first network node may indicate whether or not an AIML model with a certain identifier or identity can be retrained or modified.

One of the advantages of the proposed solution is to enable a first network node responsible to train and provide AIML models to a second network node, to maintain control over possible re-training, modifications, or updates done to the AIML model by the second network node, for instance by network nodes where the AIML model is deployed and used for inference.

Another advantage of the method is to enable the first network node to determine whether feedback information received from the second network node in association to the AIML model, such as performance feedback information, training data samples, etc., are still relevant to re-train the AIML model.

Another advantage of the methods is to enable a clear split in the training processes performed by the Model Training function and the re-training processes carried out by a second network node hosting the Model Inference function, while maintaining awareness at the Model Training function that re-training is occurring. The latter allows the Model Training function to adapt its training processes also taking into account that a retraining model is available at the node hosting the Model Inference function.

Enabling a second node to modify or retrain the model can imply simplified model(s) and hence less memory and computational resources. For example, a second node can prune the model, for example the decision tree based on new observed data. In some embodiments, allowance of retraining enables the first node to add new information to the model, in a simple example, it could comprise a new sample for the nearest neighbor regressor/classifier.

It enables better root cause analysis in a first node in case something goes wrong in the second node.

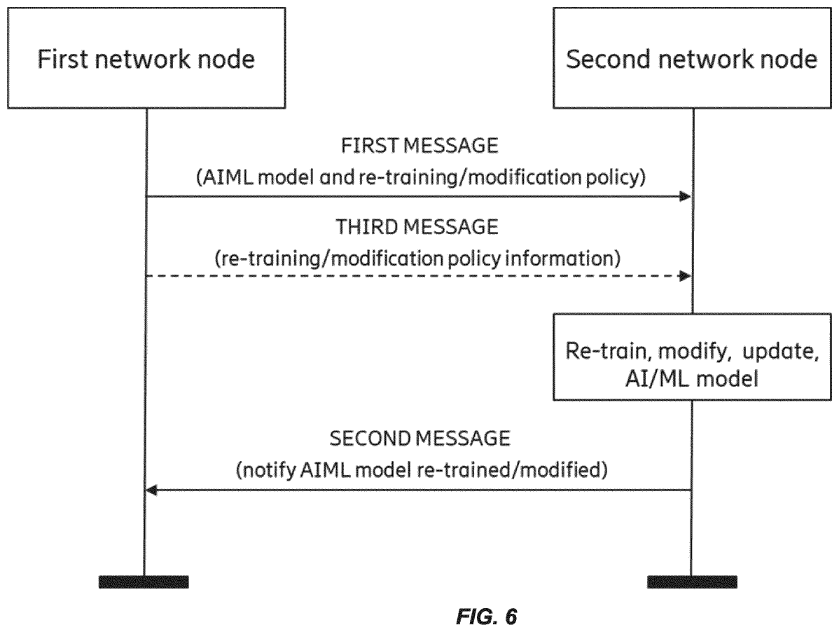

FIG. 6 is an illustration of an embodiment of the method wherein the first network node further provides to the second network node one or more information related to whether the AIML model can be re-trained or modified by the second network node. Such information can be provided either with the FIRST MESSAGE and/or (at least in part) with a THIRD MESSAGE.

In one embodiment, when the first network node indicates to the second network node that the AIML model provided by the first network node can be re-trained or modified, the first network node may further transmit to the second network node, either with the FIRST MESSAGE or with the THIRD MESSAGE, one or more information related to retraining or modifying the AIML model, which may comprise one or more of:
[1] One or more conditions or events to be fulfilled for retraining the AI/ML model
[2] One or more instructions or policies or recommendations related to re-training the AIML model
[3] One or more instructions or policies or recommendations related to modifying the AIML model
[4] A request to transmit to the first network node an indication that the second network node has updated, re-trained and/or modified an AIML model provided by the first network node. The first network node may further request information associate to the changes/modifications or updates done by the second network node to the AIML model. The first network node may further request assistance data such as the input data or data ranges used (or excluded) by the second network node to retrain/modify the model, the inputs and outputs generated by the second network node when using the re-trained/modified model. The latter information allows the first network node to deduce how the new model developed by the second network node is performing.
[5] One or more conditions or events to be fulfilled for transmitting to the first network node an indication that the second network node has updated, re-trained and/or modified an AIML model provided by the first network node, such as changes in the environment where the model is applied (e.g., if the model is used for predictions of radio parameters/conditions, the event could consist of changes of the radio planning, changes of the radio conditions)
[6] One or more specific use case(s) or time scale(s) for which re-training or modification of AIML model is possible or suggested or recommended. E.g., AIML model as provided by the first network node works well enough (or with certain expected performance if used to produce inference output related to energy savings decisions applicable on a minute time scale, but more accurate inference output for energy saving decisions at sub-second time scale are only possible if re-training is applied.

Each of the item [1]-[6] is further described in individual embodiments hereafter.

In one embodiment, non-limiting examples of [1] conditions or events provided by the first network node to the second network node to trigger the re-training or modification of an AIML model may comprise one or more of the following:
a. If the AIML model performance degrades below a certain threshold
b. If the performance of a radio feature dependent on the AIML model degrades below a certain threshold
c. If the distribution of one or more data element used as input to the model changes. Non limiting examples may comprise:
   i. If the average/mean value of at least one input feature deviates from a reference value. For instance, if the average value increases above a reference value for more than a threshold or if the average value decreases below a reference value for more than a threshold
   ii. If the standard deviation or the variance of at least one input feature increases above a reference value for more than a threshold value
d. If one or more input features are not available at the second network node
e. If one of more input features are not available for a at least a window of time at the second network node
f. If the AI/ML model has been evaluated with more than N samples, for example the second node are not allowed to retrain not sufficient statistic has been collected. The number of samples N can be based on the number of samples in the first node, for example the second node needs to collect at least as many samples as the first node.
g. That parts of the AIML model can be re-trained or modified by the second network node
   i. In case of neural network models, what layers that could be trainable/modified. Or in case of decision trees, what parts of the tree that cannot be modified.
h. If the environment within which the AI/ML model operates changes. Such changes may constitute of:
   i. Changes in the capabilities of the second network node (e.g., processing power, memory) that may condition the functioning of the AI/ML model
   ii. Changes in the use case context within which the model should be used for inference. For example, if the mode is used to predict certain radio parameters, changing of cell deployments, radio conditions etc. are within the flagged events
   iii. Changes in the availability of inputs from internal and external input data sources. For example, a decrease of input data received from neighbour RAN nodes may be flagged as an event

In one embodiment, non-limiting examples of [2] recommendations or instructions provided by the first network node to the second network node related to re-training an AIML model may comprise one or more of the following:
a. An indication or a list of the optimizers to be used to re-train the AIML model. Non-limiting examples of optimizers may include stochastic gradient-based method, gradient based methods, etc.
b. An indication or a list of the exploration strategies to be used for re-training, and the associated parameters. Non limiting examples of exploration strategies may include epsilon-greedy exploration.
c. A list of training parameter that the second network node is either recommended or instructed to be used for re-training the AIML model. Non limiting examples of training parameters may include, for instance, one or more of:
   i. An indication of the minimum or maximum batch size to be used for training
   ii. An indication of the learning rate to be used
   iii. An indication of the training steps to be used
   iv. An indication of the training iterations to be used,
   v. An indication of the data scaling factors used to train the model
   vi. An indication of the sample weight for each class, or output region, for example prioritize or exclude certain output ranges when retraining the model

In one embodiment, non-limiting examples of [3] recommendations or instructions provided by the first network node to the second network node related to modifying an AIML model may comprise one or more of the following:
a. An indication that the AIML model cannot be modified
b. An indication that the AIML model can be modified
c. An indication of one or more type of modifications to the AIML model that are allowed. This may comprise one or more of the following:
   i. One or more types of allowed AIML models that can be used to modify the AIML model provided by the first network node. Non limiting examples may include, feed-forward neural network, convolutional neural network, recurrent neural network, graph neural networks, etc.
   ii. An indication of the number of hidden layers that can be used, such as a maximum number, a minimum number, a required number, etc.
   iii. An indication of the size of hidden layers that can be used, such as a maximum number of units per layer, a minimum number of units per layer, a required number of units per layer, etc.
   iv. An indication of the type of activation function that can be used per layer. Non limiting examples of activation functions may include hyperbolic tangent function, sinusoidal function, rectified linear unit (RELU) function, sigmoid function, softmax function, linear function, etc.
   v. An indication of whether the number and/or type of input features can be changed

In one embodiment, non-limiting examples of [4] information requested by the first network node to the second network node related to re-training or modifying of an AIML model may comprise one or more in the group of:
a. An identifier or identity of a AIML model, and/or an identifier of a specific version or vendor of the AIML model, originally provided by the first network node, that second network node has re-trained, changed, modified an indication of the AIML model structure, such as number of hidden layers, number of hidden units per layer, type of activation functions used in each hidden layer, connectivity degree between layers, etc.
b. An indication of the type of AIML model (if the AIML model is modified)
c. An indication of the data scaling factors used to train the model
d. An indication of the sample weight for each class, or output region, for example prioritize or exclude certain output ranges when retraining the model
e. An indication of the exploration strategy used to train the AI/ML model and the associated parameters
f. An indication to provide the dataset used to re-train the model
g. An indication to provide input data and corresponding output data achieved via the retrained/modified model.

In one embodiment, non-limiting examples of [5] conditions or events provided by the first network node to the second network node to trigger the transmission of an indication to the first network node, the indication indicating that that the second network node has updated, re-trained and/or modified an AIML model provided by the first network node, may comprise one or more of the following:
a. If, for reference inputs provided by the first network node, the outputs produced by the updated, re-trained and/or modified AIML model differ from the associated reference outputs provided by the first network node by at least a threshold
   i. The reference outputs are the outputs produced by the AIML model provided by the first network node for reference inputs
b. If, for reference inputs provided by the first network node or a set of inputs selected by the second network node, the outputs produced by the updated, re-trained and/or modified AIML model differ from the outputs produced by the previous AIML model by at least a threshold
c. If the model parameters of the updated or re-trained AIML model differ from the model parameters of the AIML model provided by the first network node by at least a threshold
d. If the model parameters of the updated or re-trained AIML model differ from the model parameters of the previous AIML model by at least a threshold
e. If the hyperparameters of the modified AIML model differ from the hyperparameters of the AIML model provided by the first network node
f. If the hyperparameters of the modified AIML model differ from the hyperparameters of the previous AIML model
g. If the output statics of the new model has changed with a certain amount in respect to the received model from the first node
   i. For example, by measuring the output variation when using a pseudo-random input data to the model. The new ML model, ƒ_new, is evaluated by the second node using a pseudo-random generated dataset for example X=(X0, X1, . . . XN) and with the corresponding output f_new (Xk=0), f_new (Xk=1), . . . , f_new (Xk=N). Next. we compare by calculating the loss (e.g., mean squared error) between the new and the output for the original model f. The loss metric can be used to decide whether to trigger an indication.
h. If the environment within which the AI/ML model operates changes. Such changes may constitute of:
   i. Changes in the capabilities of the second network node (e.g., processing power, memory) that may condition the functioning of the AI/ML model
   ii. Changes in the use case context within which the model should be used for inference. For example, if the mode is used to predict certain radio parameters, changing of cell deployments, radio conditions etc. are within the flagged events
   iii. Changes in the availability of inputs from internal and external input data sources. For example, a decrease of input data received from neighbor RAN nodes may be flagged as an event

In one embodiment, non-limiting examples of [6] conditions provided by the first network node to the second network node related to use cases or time scale(s) can be signaled by the first network node to indicate whether and to what degree the AIML model provided by the first network node works well enough (such as with certain expected performance or up until which time scale) when used to produce inference output. In one example, related to energy savings, the first network node can indicate to the second network node that inference outputs from the model are expected to be satisfactory on a minute time scale, but more accurate inference output for energy saving decisions at sub-second time scale are only possible if re-training is applied. In another example, the first network node may indicate that the AIML model provided is trained for maximum performance in terms of energy saving, and retraining is needed to for optimal performance when energy saving decisions should be down-prioritized in favor of network retainability.

### Embodiments Related to Second Message and Fourth Message

In one embodiment of the method, the SECOND MESSAGE received by the first network node from the second network node, may comprise, in one example, one or more of the following information elements:
a. An identity or an identifier of at least an AIML model, and/or an identifier of a specific version or vendor of the AIML model, wherein such AIML model may in some examples be provided by the first network node to the second network node.
b. An identity or an identifier of at least an AIML model, and/or an identifier of a specific version or vendor of the AIML model, wherein such AIML model is associated to the model retrained/modified by the second network node and to its related information contained in the second message
c. An indication that the at least one AIML model received from the first network node has been re-trained or has not been re-trained.
d. An indication that the at least one AIML model received from the first network node will be re-trained or will not be re-trained
e. An indication that the at least one AIML model received from the first network node has been modified node or has not been modified
f. An indication that the at least one AIML model received from the first network node will be modified or will not be modified.
g. And indication of a reason why the AIML model will be modified, for example:
   i. Performance degradation
   ii. High computation complexity and memory consumption
h. Information about the type of training data used, e.g., Data definition and semantics, range of training data values (e.g., Training data used within range [x, . . . , y]), amount of data used (e.g., X million training data samples used for training), data used per data value range (e.g., X million training data samples within range [x, . . . , y] used for training)
i. Instances of the outputs derived with the retrained/modified model and associated sample inputs
j. An indication that the model has been augmented or reduced. Such indication may either be an enumerated field with values indicating “Augmented model” or “reduced model”, or it may be a more detailed indication of how the model has been augmented/reduced, for example, in the case the model consists of a neural network, possible indications could be “Neural network augmented to X number of layers ”, “Neural network reduced to X number of layers”
k. An indication that the model has been modified and that the type of AI model has been changed. For example, the indication could consist of different types of model types such as Linear Regression, Neural Network, Logistic Regression, Decision Trees, etc.
l. The retrained/modified model. Such retrained/modified model may be taken into account by the first network node for further development. Alternatively, the retrained/modified model may be considered by the first network node for comparison with the models trained by the first network node. Such comparison may lead to a better understanding of how to best train a model that fits the requirements and use cases at the second network node.
m. An indication of whether the second network node or a third network node has used or not used the AIML model, the frequency of use, the time since when the second network node has used (or not used) the AIML model.
n. An identity or an identifier of the network node that has re-trained or modified the AIML model provided by the first network node.

In addition, the SECOND MESSAGE may comprise an explicit or implicit information indicating that any of the reported information associated to re-training or modifying an AIML model has been done by the second network node itself or by a third network node. Identities of the node that has performed retraining/modifications may be provided.

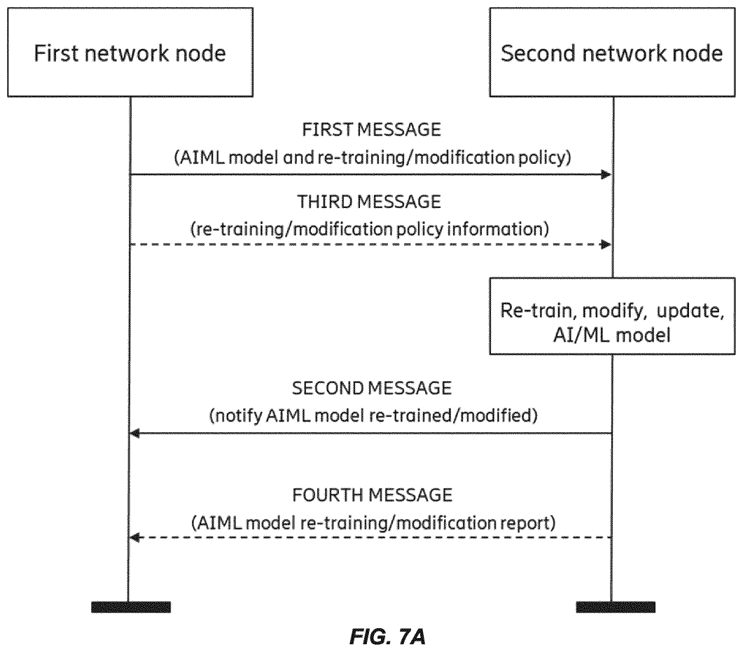

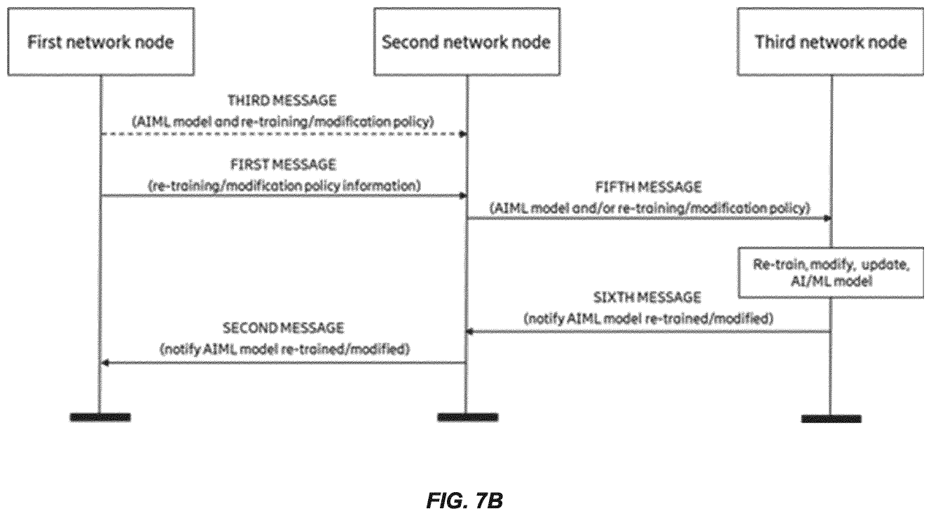

FIG. 7A is an illustration of an embodiment of the method wherein the first network node further receives a THIRD MESSSAGE from the second network node indicating that a model provided by the first network node to the second network node has been re-trained or modified by the second network node.

In one embodiment of the method, illustrated in FIG. 7A, the first network node may further:
Receive the SECOND MESSAGE from the second network node in response to a FIRST MESSAGE or to a THIRD MESSAGE transmitted by the first network node to the second network node.

In this case, for example, one or more information provided by the SECOND MESSAGE may be related to information requested by the first network node by means of the FIRST MESSAGE or the THIRD MESSAGE.

In one alternative embodiment of the method, the SECOND MESSAGE received by the first network node from the second network node, may comprise a request for the first network node to indicate whether the AIML model provided to the second network node can be re-trained or modified (by the second network node or by a third network node). In one example, the request from the second network node may comprise one or more of the following information elements:
a. An identity or an identifier of at least an AIML model, and/or an identifier of a specific version or vendor of the AIML model, wherein such AIML model may in some exampled be provided by the first network node to the second network node.
b. A request of whether the at least one AIML model can be re-trained
c. A request of whether the at least one AIML model can be modified
d. An indication of at least a network node to which the request to re-train or modify the at least one AIML model refers to. This indication may comprise, in one example, the identity or an identifier of:
   i. The second network node
   ii. A third network node

In one embodiment, the SECOND MESSAGE may comprise indications on whether the second network node has used or not used the AIML model, the corresponding AIML model version(s) and vendor(s), the frequency of use (e.g., how many times or for how long the AIML model has been used, the time since when the second network node has used (or not used) the AIML model.

In one embodiment of the method, illustrated in FIG. 7A, the first network node may further receive from the second network node, either via the SECOND MESSAGE or via a FOURTH MESSAGE, a feedback report related to how an AIML model provided by the first network node to the second network node has been re-trained or modified by the second network node. In one example, the feedback report provided by the second network node in association to re-training or modifying an AIML model may comprise one or more information elements in the group of:
a. [A] One or more information related to at least a condition or event that triggered the re-training or the modification of the AIML model (either at the second network node or in a third network node).
b. [B] One or more information related to how the AIML model has been re-trained
c. [C] One or more information related to how the AIML model has been modified

Examples of [A], [B] and [C] are provided hereafter:

Non-limiting examples of [A] conditions or events that could be reported by the second network node as triggers for re-training or modifying the AIML model may comprise one or more in the group:
a. The AIML model performance falls degrades below a certain threshold
b. The performance of a radio feature dependent on the AIML model degrades below a certain threshold
c. The distribution of one or more data element used as input to the model changes. Non limiting examples may comprise
   i. If the average/mean value of at least one input feature deviates from a reference value. For instance, if the average value increases above a reference value for more than a threshold or if the average value decreases below a reference value for more than a threshold
   ii. If the standard deviation or the variance of at least one input feature increases above a reference value for more than a threshold value
d. One or more input features are not available at the second network node
e. One of more input features are not available for a at least a window of time at the second network node

Non-limiting examples of [B] information provided by the network node related to how the AIML model has been re-trained may comprise one or more of the following:
a. An indication or a list of the optimizers to be used to re-train the AIML model. Non-limiting examples of optimizers may include stochastic gradient-based method, gradient based methods, etc.
b. An indication or a list of the exploration strategies to be used for re-training, and the associated parameters. Non limiting examples of exploration strategies may include epsilon-greedy exploration.
c. A list of training parameter that the second network node is either recommended or instructed to use for re-training. Non limiting examples of training parameters may include, for instance,
   i. An indication of the minimum or maximum batch size to be used for training
   ii. An indication of the learning rate to be used
   iii. An indication of the training steps to be used
   iv. An indication of the training iterations to be used,
   v. An indication of the data scaling factors used to train the model
   vi. An indication of the sample weight for each class, or output region, for example prioritize or exclude certain output ranges when retraining the model
d. One or more data samples used to re-train the AIML model

Non-limiting examples of [C] information reported by the second network node related to how the AIML model has been modified may comprise one or more of the following:
a. The type of AIML model used to modify the original AIML model
   i. Non limiting examples may include, feed-forward neural network, convolutional neural network, recurrent neural network, graph neural networks, etc.
b. Information related to the structure of the AIML model. Non limiting examples of information may comprise, for instance, one or more of
   i. the number of hidden layers.
   ii. the size of hidden layers (e.g., number of units per layer)
   iii. the type of activation function used in each layer. Non limiting examples of activation functions may include hyperbolic tangent function, sinusoidal function, rectified linear unit (RELU) function, sigmoid function, softmax function, linear function, etc.
   iv. An indication of whether the number and/or type of input features can be changed

Additional signaling aspects for second network node

In one embodiment, illustrated in FIG. 7B the second network node may additionally:
Transmit a FIFTH MESSAGE to a third network node comprising the AIML model received from the first network node and/or one or more information, received from the first network node, related to re-training or modifying the AIML model.
Receive a SIXTH MESSAGE from the third network node comprising at least an indication that the third network node has re-trained or modified the AIML model received from the second network node.

The second network node can therefore act as a relay node between the first network node and the third network node. This could be required, for instance, when a direct interface does not exist between such network nodes. An example of such scenario, further discussed below, could be when the first network node is an operation and management (OAM) node, while the second and third network nodes belong to an NG-RAN node with split architecture, such as a gNB-CU-CP and a gNB-DU, respectively.

FIG. 7B is an illustration of a non-limiting example where the second network node transmits a FIFTH MESSAGE to a third network node comprising the AIML model received from the first network node and/or one or more information related to retraining or modifying an AIML.

In one embodiment, the second network node may determine the FIFTH MESSAGE based on the FIRST MESSAGE or the THIRD MESSAGE received from the first network node. As such, the FIFTH MESSAGE may comprise one or multiple or all the characteristics (e.g., information elements) of the FIRST MESSAGE and/or the THIRD MESSAGE received by the second network node from the first network node defined herein.

For example, the FIFTH MESSAGE may comprise one or more information related to retraining or modifying an AIML model in the group of:

An identity or an identifier of an AIML model and/or an identifier of a specific version or vendor of the AIML model to which the transmitted information is applicable to or associated to.

An indication that the AIML model cannot be re-trained or modified

An indication that the AIML model can be re-trained or modified

An indication that AIML model re-training or modification is suggested or recommended (e.g., for a particular use case or to fulfil some specific time scale requirements)

In another example, the FIFTH MESSAGE may comprise one or more information related to retraining or modifying the AIML model in the group of:
[1] One or more conditions or events to be fulfilled for retraining the AI/ML model
[2] One or more instructions or policies or recommendations related to re-training the AIML model
[3] One or more instructions or policies or recommendations related to modifying the AIML model
[4] A request to transmit to the first network node, or to the second network node, an indication that the third network node has updated, re-trained and/or modified an AIML model provided by the first network node, via the second network node. The second network node may further request information associate to the changes/modifications or updates done by the third network node to the AIML model. The second network node may further request assistance data such as the input data or data ranges used (or excluded) by the third network node to retrain/modify the model, the inputs and outputs generated by the third network node when using the re-trained/modified model. The latter information allows the first network node, or the second network node, to deduce how the new model developed by the third network node is performing.
[5] One or more conditions or events to be fulfilled for transmitting to the first network node, or to the second network node, an indication that the third network node has updated, re-trained and/or modified an AIML model provided by the first network node, via the second network node, such as changes in the environment where the model is applied (e.g., if the model is used for predictions of radio parameters/conditions, the event could consist of changes of the radio planning, changes of the radio conditions)
[6] One or more specific use case(s) or time scale(s) for which re-training or modification of AIML model is possible or suggested or recommended. E.g., AIML model as provided by the first network node, via the second network node, works well enough (or with certain expected performance if used to produce inference output related to energy savings decisions applicable on a minute time scale, but more accurate inference output for energy saving decisions at sub-second time scale are only possible if re-training is applied.

In some embodiments, the description of information elements provided above for the FIRST MESSAGE and/or the THIRD MESSAGE could be repeated for the FIFTH MESSAGE.

In another embodiment, the second network node may determine the SECOND MESSAGE and/or the FOURTH MESSAGE based on the SIXTH MESSAGE received from the third network node. As such, the SECOND MESSAGE and/or the FOURTH MESSAGE may comprise one or more information elements provided by the third network node to the second network node via the SIXTH MESSAGE. Therefore, the SIXTH MESSAGE may comprise one, multiple, or all the characteristics (e.g., information elements) described above for the SECOND MESSAGE and/or the FOURTH MESSAGE transmitted by the second network node to the first network node.

In some embodiments, the description of information elements provided above for the SECOND MESSAGE and/or the FOURTH MESSAGE could be repeated for the SIXTH MESSAGE.

### Method for a Third Network Node

The invention discloses a method executed by a third network node to control the re-training or modification of an AIML model, in a radio communication network comprising the steps of:
a. Receiving a FIFTH MESSAGE from a second network node comprising the AIML model received from the first network node and/or one or more information, received from the first network node, related to re-training or modifying the AIML model.
b. Transmitting a SIXTH MESSAGE from the second network node comprising at least an indication that the third network node has re-trained or modified the AIML model received from the second network node.

In some embodiments, any of the description included herein regarding the other network nodes also applies to the third network node.

### Embodiments Related to Network Node Types and Architecture

Regarding possible scenarios of applicability of the methods:
a. the first network node and/or the second network node can be different RAN nodes (e.g., two gNBs, or two eNBs, or two en-gNBs, or two ng-eNBs)
b. the first network node and/or the second network node can be different nodes/functions of a same RAN node (e.g., a gNB-CU-CP and a gNB-DU, or a gNB-CU-CP and a gNB-CU-UP)
c. the first network node can be a RAN node (e.g., two gNBs, or two eNBs, or two en-gNBs, or two ng-eNBs) and the second network node can be component/nodes/functions of a second RAN node (e.g., gNB-CU-CP)
d. the first network node and/or the second network node can pertain to the same Radio Access Technology (e.g., e.g., E-UTRAN, LTE, NG-RAN, ORAN, ONAP, WiFi, etc.) or to different Radio Access Technologies (e.g., one to NR and the other to E-UTRAN or WiFi)
e. the first network node and/or the second network node can pertain to the same RAN system (e.g., E-UTRAN, LTE, NG-RAN, ORAN, ONAP, WiFi, etc.) or to different RAN systems (e.g., one to NG-RAN and the other to E-UTRAN)
f. the first network node and the second network node may be connected via a direct signaling connection (e.g., two gNB via XnAP), or an indirect signaling connection (e.g., an e-NB and a gNB via S1AP, NGAP and one or more Core Network nodes, e.g., an MME and an AMF)
g. the first network node can be a management system, such as the OAM system or the SMO, while the second network node can consist of a RAN node or function.
h. The first network node can be a RAN node or function while the second network node can be a management system, such as the OAM or the SMO.
i. the first network node can be a core network node or function, such a 5GC function, while the second network node can consist of a RAN node or function.
j. The first network node can be a RAN node or function while the second network node can be a core network node or function, such a 5GC function.

In one non-limiting example illustrated in FIG. 8, the first network node can be an Orchestration And Management (OAM) node or a Service and Management Orchestration (SMO) node, while the second network node could be a RAN node. Non limiting examples of RAN nodes may include, an E-UTRAN node (such as an eNB, en-ENB, etc.), a NG-RAN node (such as gNB, gNB-CU-CP, gNB-DU, etc.), a WiFi access point, etc.

FIG. 8 is an example of the method wherein the first network node is an OAM or a SMO node, while the second network node could be a RAN node.

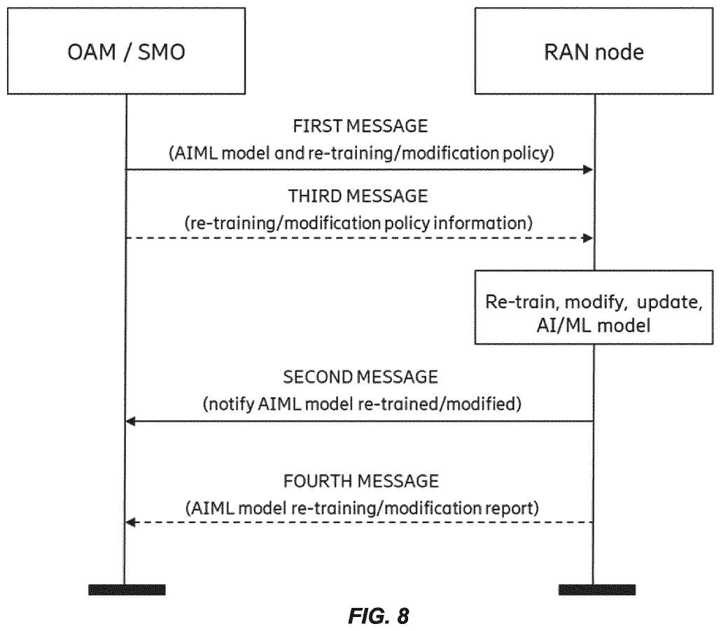

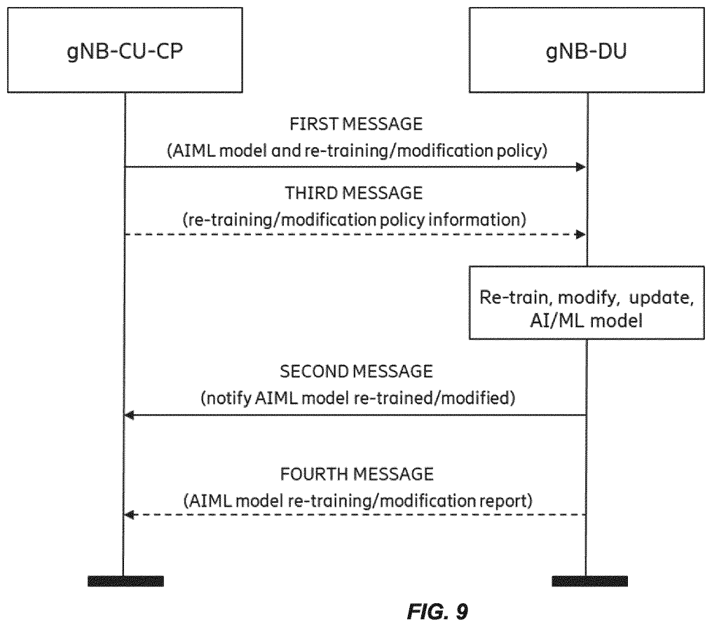

FIG. 9 is an illustration of a non-limiting example of the method wherein the first network node is a gNB-CU-CP, and the second network node is a gNB-DU. In this example, the messages disclosed by the method would be transmitted over the F1 (e.g., F1AP) interface of an NG-RAN system. However, different combinations of E-UTRAN and NG-RAN nodes may lead to different implementation of the embodiments where the messages herein disclosed to be transmitted/received between a first network node and second network node would be conveyed over different interfaces of the E-UTRAN and NG-RAN systems. Non limiting examples of such interfaces are S1AP, X2AP, NGAP, XnAP, F1AP, E1AP, etc.

Similarly, in alternative implementations where the first and second network node represent nodes of an ORAN system, the messages herein disclosed to be transmitted/received between a first network node and second network node would be conveyed over different interfaces of the ORAN system. In the same way, the method could be applied to network nodes of other Radio Access Technologies (RATs), such as ONAP, WiFi, etc., in which case the specific communication interface of such RATs would be used to signal the messages herein disclosed between two network nodes.

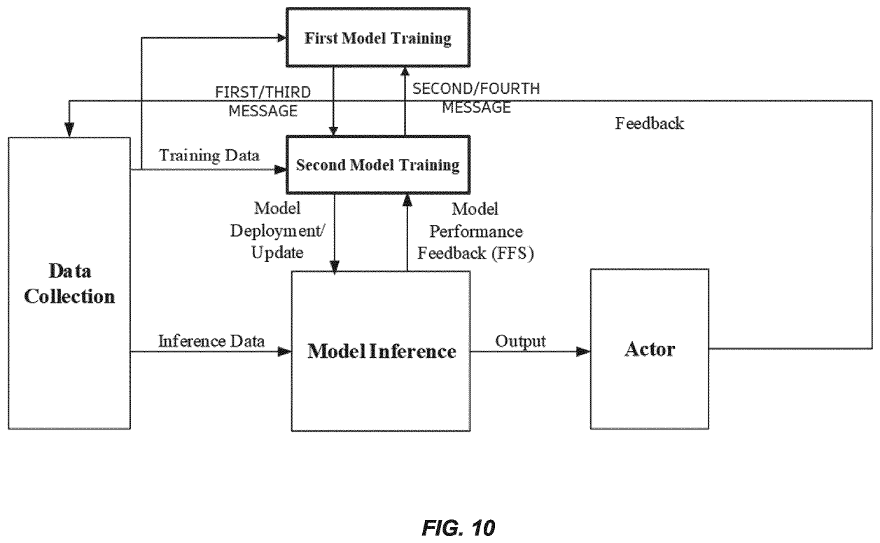

FIG. 10 illustrates a non-limiting example of how the method can be mapped to the AIML functional framework for the NG-RAN and E-UTRAN system defined by 3GPP. In one possible implementation of the method, the first network node is a logical node hosting a first training function, while the second network node is a second logical node hosting a second training function. In this case two logical nodes hosting two model training functions interact by exchanging messages as defined in this disclosure. Additionally, both nods hosting a training function could have an interface with a data collection function, but only one node hosting a model training function would have an interface with a node hosting a model inference function.

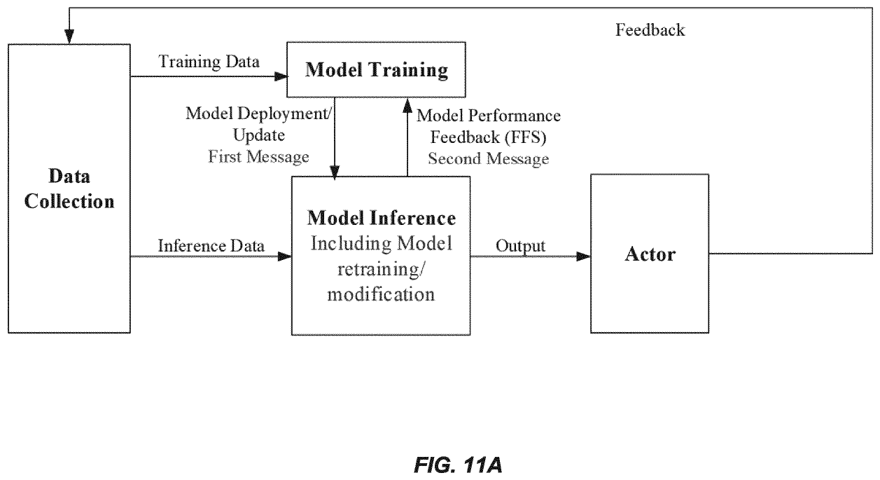

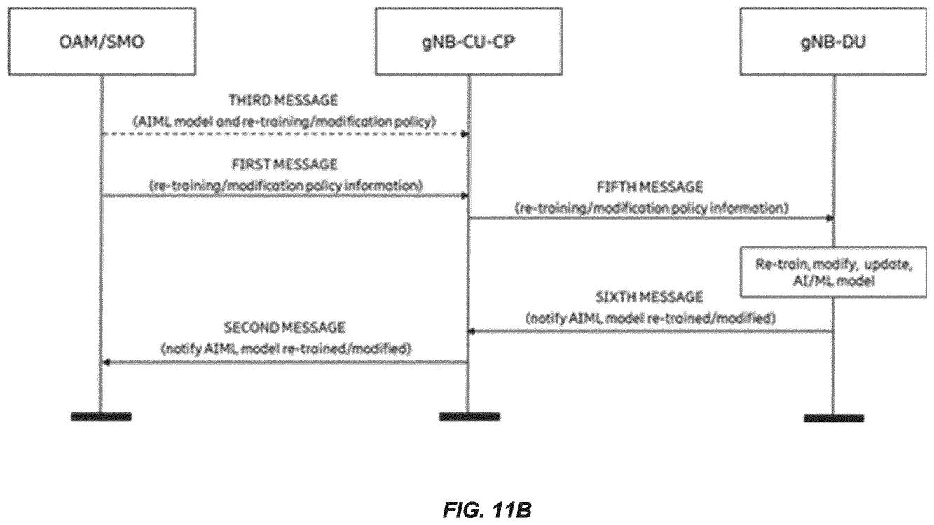

In another example of how the methods may be mapped to the AI/ML functional framework developed by 3GPP RAN3 is shown in FIG. 11A which illustrates a non-limiting example of how the method can be mapped to the AIML functional framework for the NG-RAN and E-UTRAN system defined by RAN3 3GPP.

In the example in FIG. 11A, the first network node is the node hosting the Model Training Function, while the second network node is the node hosting the Model Inference function. According to this structure the node hosting the Model Inference function is also hosting the function responsible for retraining and modifying a model received by the first network node.

The node hosting the Model Training function is the node responsible for deploying an AI/ML model to the second network node and to signal information concerning retraining and modification as described in other embodiments.

In this structure the first message is the Model Deployment/Update message. The second message is what is represented as the Model Performance Feedback. In one embodiment the “Model Performance Feedback” message may be renamed in a way to better resemble the information carried by message 2. A potential name for this message could be Model Status Update.

FIG. 11B illustrates an example of a scenario where the first network node is an Operation And Maintenance (OAM) node, while the second and third network nodes belong to an NG-RAN node with split architecture, such as a gNB-CU-CP and a gNB-DU, respectively.

FIG. 11B shows a non-limiting example of such scenario where the first network node is an OAM node or a service and management orchestration (SMO) node, while the second and third network nodes belong to an NG-RAN node with split architecture, such as a gNB-CU-CP and a gNB-DU, respectively. In one exemplifying case, the first network node (OAM) and the second network node (gNB-CU-CP) may host a first and a second training function, while the third network node (gNB-DU) could host an inference function. In this example, the gNB-CU-CP may re-train or modify an AIML model provided by an OAM/SMO and provide it to a gNB-DU for inference. In this case, the OAM/SMO may indicate to the gNB-CU-CP that the AIML model provided by the OAM/SMO can be re-trained or modified by the gNB-CU-CP. On the other hand, the gNB-CU-CP may indicate to the gNB-DU that the AIML model provided by the gNB-CU-CP cannot be re-trained or modified.

In other examples, also the third network (gNB-DU) node may be the host of a training function. An AIML model generated/trained by an OAM/SMO node could be provided to a gNB-DU via a gNB-CU-CP, and the gNB-DU may be required to re-train or modify the AIML model prior to using it for inference. The gNB-CU-CP in this case could act as a relay node.

In another embodiment, the first network node receives an AIML model from a third network node and does not host a AIML training function, while the second network node hosts a AIML training function. In this case, the first network node may:
a. Receive a SEVENTH MESSAGE from a third network node comprising an AIML model, wherein the third node may host a training function
b. Transmit the FIRST MESSAGE to the second network node comprising the AIML model received from the third network node.

In another embodiment, the first network node receives an AIML model from a third network node and does not host a AIML training function, and the second network node does not host a AIML training function. In this case, the second network node may:
a. Receive the FIRST MESSAGE from the first network node comprising the AIML model
b. Transmit an EIGHTH MESSAGE to a fourth network node, wherein the fourth network node may host a training function

### Method in a Second Network Node

Some embodiments of the present disclosure include a method executed by a second network node to control the re-training or modification of an AIML model received from a first network node, in a radio communication network comprising the steps of:
a. Receiving a FIRST MESSAGE from the first network node comprising an AIML model
b. Transmitting a SECOND MESSAGE to the first network node comprising an indication that the second network node has re-trained or modified the AIML model received from the first network node.

Therefore, the SECOND MESSAGE may provide a notification to the first network node that the second network node has re-trained or modified an AIML model provided by the first network node.

In one embodiment, the second network node may additionally
a. Receive within the FIRST MESSAGE or with a THIRD MESSAGE, one or more information associated to the AIML indicating
   i. That the AIML model cannot be re-trained or modified by the second network node
   ii. That the AIML model can be re-trained or modified by the second network node
   iii. That AIML model re-training or modification by the second network node is suggested or recommended (e.g., for a particular use case or to fulfil some specific time scale requirements)

In additional embodiments, the second network node may additionally transmit either via the SECOND MESSAGE or via a FOURTH MESSAGE, a feedback report related to how an AIML model provided by the first network node to the second network node has been re-trained or modified by the second network node. The feedback report provided by the second network node in association to re-training or modifying an AIML model may comprise one or more information elements in the group of:
a. One or more information related to at least a condition or event that triggered the re-training or the modification of the AIML model (either at the second network node or in a third network node).
b. One or more information related to how the AIML model has been re-trained
c. One or more information related to how the AIML model has been modified
d. One or more information related to why the AIML model has been modified or re-trained

Embodiments related to the SECOND MESSAGE and FOURTH MESSAGE are described within the method of the first network node above.

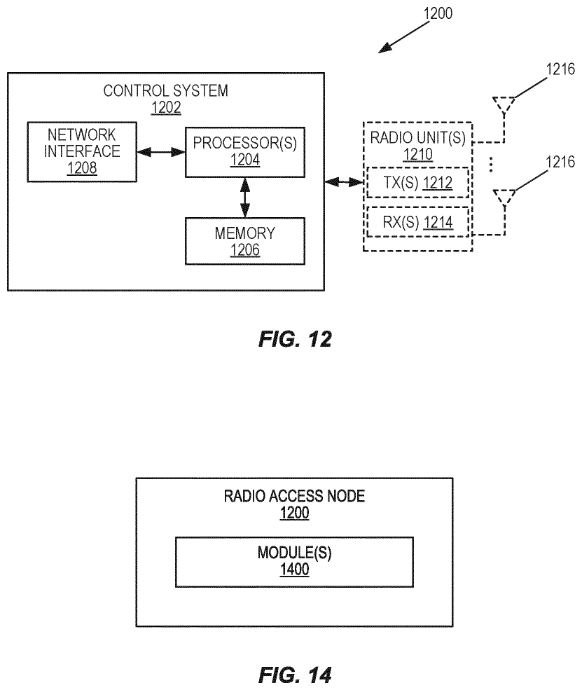

FIG. 12 is a schematic block diagram of a radio access node 1200 according to some embodiments of the present disclosure. Additionally, FIG. 12 could illustrate a first network node and/or a second network node which can be any of the radio access nodes described herein, core network nodes described herein, or any other suitable nodes. Optional features are represented by dashed boxes. The radio access node 1200 may be, for example, a base station 202 or 206 or a network node that implements all or part of the functionality of the base station 202 or gNB described herein. As illustrated, the radio access node 1200 includes a control system 1202 that includes one or more processors 1204 (e.g., Central Processing Units (CPUs), Application Specific Integrated Circuits (ASICs), Field Programmable Gate Arrays (FPGAs), and/or the like), memory 1206, and a network interface 1208. The one or more processors 1204 are also referred to herein as processing circuitry. In addition, the radio access node 1200 may include one or more radio units 1210 that each includes one or more transmitters 1212 and one or more receivers 1214 coupled to one or more antennas 1216. The radio units 1210 may be referred to or be part of radio interface circuitry. In some embodiments, the radio unit(s) 1210 is external to the control system 1202 and connected to the control system 1202 via, e.g., a wired connection (e.g., an optical cable). However, in some other embodiments, the radio unit(s) 1210 and potentially the antenna(s) 1216 are integrated together with the control system 1202. The one or more processors 1204 operate to provide one or more functions of a radio access node 1200 as described herein. In some embodiments, the function(s) are implemented in software that is stored, e.g., in the memory 1206 and executed by the one or more processors 1204.

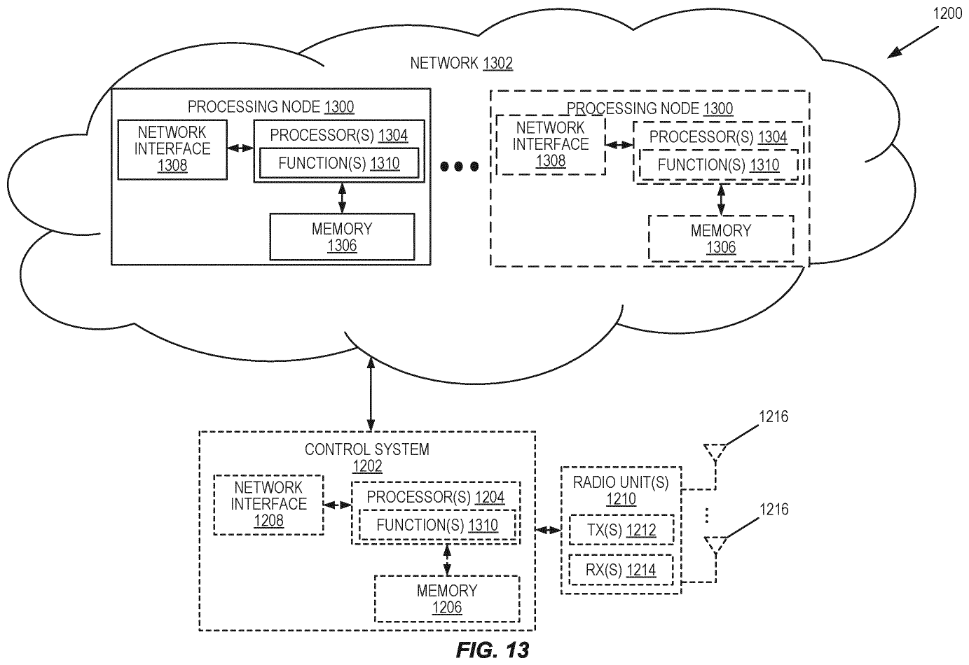

FIG. 13 is a schematic block diagram that illustrates a virtualized embodiment of the radio access node 1200 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1200 in which at least a portion of the functionality of the radio access node 1200 is implemented as a virtual component(s) (e.g., via a virtual machine(s) executing on a physical processing node(s) in a network(s)). As illustrated, in this example, the radio access node 1200 may include the control system 1202 and/or the one or more radio units 1210, as described above. The control system 1202 may be connected to the radio unit(s) 1210 via, for example, an optical cable or the like. The radio access node 1200 includes one or more processing nodes 1300 coupled to or included as part of a network(s) 1302. If present, the control system 1202 or the radio unit(s) are connected to the processing node(s) 1300 via the network 1302. Each processing node 1300 includes one or more processors 1304 (e.g., CPUs, ASICs, FPGAs, and/or the like), memory 1306, and a network interface 1308.

In this example, functions 1310 of the radio access node 1200 described herein are implemented at the one or more processing nodes 1300 or distributed across the one or more processing nodes 1300 and the control system 1202 and/or the radio unit(s) 1210 in any desired manner. In some particular embodiments, some or all of the functions 1310 of the radio access node 1200 described herein are implemented as virtual components executed by one or more virtual machines implemented in a virtual environment(s) hosted by the processing node(s) 1300. As will be appreciated by one of ordinary skill in the art, additional signaling or communication between the processing node(s) 1300 and the control system 1202 is used in order to carry out at least some of the desired functions 1310. Notably, in some embodiments, the control system 1202 may not be included, in which case the radio unit(s) 1210 communicate directly with the processing node(s) 1300 via an appropriate network interface(s).

In some embodiments, a computer program including instructions which, when executed by at least one processor, causes the at least one processor to carry out the functionality of radio access node 1200 or a node (e.g., a processing node 1300) implementing one or more of the functions 1310 of the radio access node 1200 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the radio access node 1200 according to some other embodiments of the present disclosure. The radio access node 1200 includes one or more modules 1400, each of which is implemented in software. The module(s) 1400 provide the functionality of the radio access node 1200 described herein. This discussion is equally applicable to the processing node 1300 of FIG. 13 where the modules 1400 may be implemented at one of the processing nodes 1300 or distributed across multiple processing nodes 1300 and/or distributed across the processing node(s) 1300 and the control system 1202.

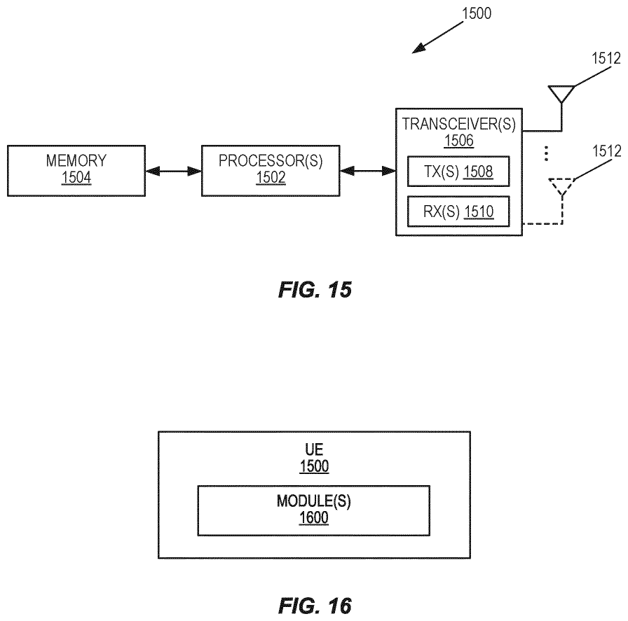

FIG. 15 is a schematic block diagram of a wireless communication device 1500 according to some embodiments of the present disclosure. As illustrated, the wireless communication device 1500 includes one or more processors 1502 (e.g., CPUs, ASICs, FPGAs, and/or the like), memory 1504, and one or more transceivers 1506 each including one or more transmitters 1508 and one or more receivers 1510 coupled to one or more antennas 1512. The transceiver(s) 1506 includes radio-front end circuitry connected to the antenna(s) 1512 that is configured to condition signals communicated between the antenna(s) 1512 and the processor(s) 1502, as will be appreciated by on of ordinary skill in the art. The processors 1502 are also referred to herein as processing circuitry. The transceivers 1506 are also referred to herein as radio circuitry. In some embodiments, the functionality of the wireless communication device 1500 described above may be fully or partially implemented in software that is, e.g., stored in the memory 1504 and executed by the processor(s) 1502. Note that the wireless communication device 1500 may include additional components not illustrated in FIG. 15 such as, e.g., one or more user interface components (e.g., an input/output interface including a display, buttons, a touch screen, a microphone, a speaker(s), and/or the like and/or any other components for allowing input of information into the wireless communication device 1500 and/or allowing output of information from the wireless communication device 1500), a power supply (e.g., a battery and associated power circuitry), etc.

In some embodiments, a computer program including instructions which, when executed by at least one processor, causes the at least one processor to carry out the functionality of the wireless communication device 1500 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the wireless communication device 1500 according to some other embodiments of the present disclosure. The wireless communication device 1500 includes one or more modules 1600, each of which is implemented in software. The module(s) 1600 provide the functionality of the wireless communication device 1500 described herein.

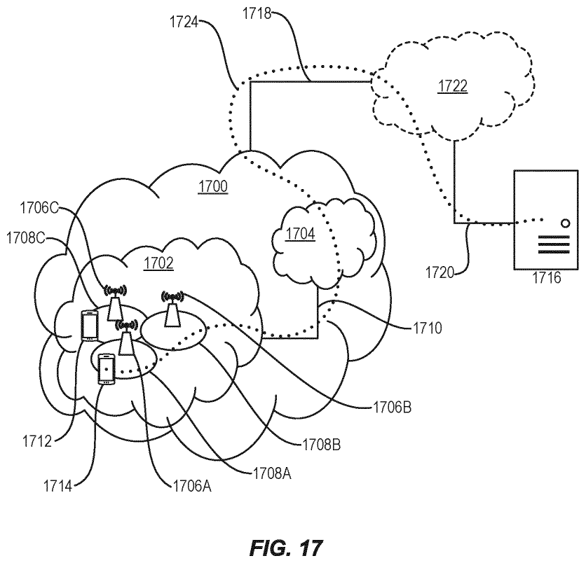

With reference to FIG. 17, in accordance with an embodiment, a communication system includes a telecommunication network 1700, such as a 3GPP-type cellular network, which comprises an access network 1702, such as a RAN, and a core network 1704. The access network 1702 comprises a plurality of base stations 1706A, 1706B, 1706C, such as Node Bs, eNBs, gNBs, or other types of wireless Access Points (APs), each defining a corresponding coverage area 1708A, 1708B, 1708C. Each base station 1706A, 1706B, 1706C is connectable to the core network 1704 over a wired or wireless connection 1710. A first UE 1712 located in coverage area 1708C is configured to wirelessly connect to, or be paged by, the corresponding base station 1706C. A second UE 1714 in coverage area 1708A is wirelessly connectable to the corresponding base station 1706A. While a plurality of UEs 1712, 1714 are illustrated in this example, the disclosed embodiments are equally applicable to a situation where a sole UE is in the coverage area or where a sole UE is connecting to the corresponding base station 1706.

The telecommunication network 1700 is itself connected to a host computer 1716, which may be embodied in the hardware and/or software of a standalone server, a cloud-implemented server, a distributed server, or as processing resources in a server farm. The host computer 1716 may be under the ownership or control of a service provider or may be operated by the service provider or on behalf of the service provider. Connections 1718 and 1720 between the telecommunication network 1700 and the host computer 1716 may extend directly from the core network 1704 to the host computer 1716 or may go via an optional intermediate network 1722. The intermediate network 1722 may be one of, or a combination of more than one of, a public, private, or hosted network; the intermediate network 1722, if any, may be a backbone network or the Internet; in particular, the intermediate network 1722 may comprise two or more sub-networks (not shown).

The communication system of FIG. 17 as a whole enables connectivity between the connected UEs 1712, 1714 and the host computer 1716. The connectivity may be described as an Over-the-Top (OTT) connection 1724. The host computer 1716 and the connected UEs 1712, 1714 are configured to communicate data and/or signaling via the OTT connection 1724, using the access network 1702, the core network 1704, any intermediate network 1722, and possible further infrastructure (not shown) as intermediaries. The OTT connection 1724 may be transparent in the sense that the participating communication devices through which the OTT connection 1724 passes are unaware of routing of uplink and downlink communications. For example, the base station 1706 may not or need not be informed about the past routing of an incoming downlink communication with data originating from the host computer 1716 to be forwarded (e.g., handed over) to a connected UE 1712. Similarly, the base station 1706 need not be aware of the future routing of an outgoing uplink communication originating from the UE 1712 towards the host computer 1716.

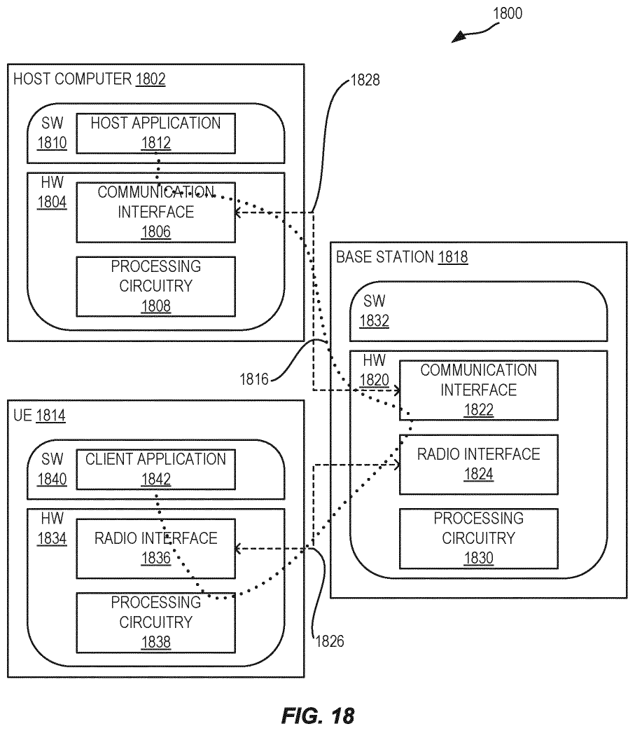

Example implementations, in accordance with an embodiment, of the UE, base station, and host computer discussed in the preceding paragraphs will now be described with reference to FIG. 18. In a communication system 1800, a host computer 1802 comprises hardware 1804 including a communication interface 1806 configured to set up and maintain a wired or wireless connection with an interface of a different communication device of the communication system 1800. The host computer 1802 further comprises processing circuitry 1808, which may have storage and/or processing capabilities. In particular, the processing circuitry 1808 may comprise one or more programmable processors, ASICs, FPGAs, or combinations of these (not shown) adapted to execute instructions. The host computer 1802 further comprises software 1810, which is stored in or accessible by the host computer 1802 and executable by the processing circuitry 1808. The software 1810 includes a host application 1812. The host application 1812 may be operable to provide a service to a remote user, such as a UE 1814 connecting via an OTT connection 1816 terminating at the UE 1814 and the host computer 1802. In providing the service to the remote user, the host application 1812 may provide user data which is transmitted using the OTT connection 1816.

The communication system 1800 further includes a base station 1818 provided in a telecommunication system and comprising hardware 1820 enabling it to communicate with the host computer 1802 and with the UE 1814. The hardware 1820 may include a communication interface 1822 for setting up and maintaining a wired or wireless connection with an interface of a different communication device of the communication system 1800, as well as a radio interface 1824 for setting up and maintaining at least a wireless connection 1826 with the UE 1814 located in a coverage area (not shown in FIG. 18) served by the base station 1818. The communication interface 1822 may be configured to facilitate a connection 1828 to the host computer 1802. The connection 1828 may be direct or it may pass through a core network (not shown in FIG. 18) of the telecommunication system and/or through one or more intermediate networks outside the telecommunication system. In the embodiment shown, the hardware 1820 of the base station 1818 further includes processing circuitry 1830, which may comprise one or more programmable processors, ASICs, FPGAs, or combinations of these (not shown) adapted to execute instructions. The base station 1818 further has software 1832 stored internally or accessible via an external connection.

The communication system 1800 further includes the UE 1814 already referred to. The UE's 1814 hardware 1834 may include a radio interface 1836 configured to set up and maintain a wireless connection 1826 with a base station serving a coverage area in which the UE 1814 is currently located. The hardware 1834 of the UE 1814 further includes processing circuitry 1838, which may comprise one or more programmable processors, ASICs, FPGAs, or combinations of these (not shown) adapted to execute instructions. The UE 1814 further comprises software 1840, which is stored in or accessible by the UE 1814 and executable by the processing circuitry 1838. The software 1840 includes a client application 1842. The client application 1842 may be operable to provide a service to a human or non-human user via the UE 1814, with the support of the host computer 1802. In the host computer 1802, the executing host application 1812 may communicate with the executing client application 1842 via the OTT connection 1816 terminating at the UE 1814 and the host computer 1802. In providing the service to the user, the client application 1842 may receive request data from the host application 1812 and provide user data in response to the request data. The OTT connection 1816 may transfer both the request data and the user data. The client application 1842 may interact with the user to generate the user data that it provides.

It is noted that the host computer 1802, the base station 1818, and the UE 1814 illustrated in FIG. 18 may be similar or identical to the host computer 1716, one of the base stations 1706A, 1706B, 1706C, and one of the UEs 1712, 1714 of FIG. 17, respectively. This is to say, the inner workings of these entities may be as shown in FIG. 18 and independently, the surrounding network topology may be that of FIG. 17.

In FIG. 18, the OTT connection 1816 has been drawn abstractly to illustrate the communication between the host computer 1802 and the UE 1814 via the base station 1818 without explicit reference to any intermediary devices and the precise routing of messages via these devices. The network infrastructure may determine the routing, which may be configured to hide from the UE 1814 or from the service provider operating the host computer 1802, or both. While the OTT connection 1816 is active, the network infrastructure may further take decisions by which it dynamically changes the routing (e.g., on the basis of load balancing consideration or reconfiguration of the network).

The wireless connection 1826 between the UE 1814 and the base station 1818 is in accordance with the teachings of the embodiments described throughout this disclosure. One or more of the various embodiments improve the performance of OTT services provided to the UE 1814 using the OTT connection 1816, in which the wireless connection 1826 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 1816 between the host computer 1802 and the UE 1814, in response to variations in the measurement results. The measurement procedure and/or the network functionality for reconfiguring the OTT connection 1816 may be implemented in the software 1810 and the hardware 1804 of the host computer 1802 or in the software 1840 and the hardware 1834 of the UE 1814, or both. In some embodiments, sensors (not shown) may be deployed in or in association with communication devices through which the OTT connection 1816 passes; the sensors may participate in the measurement procedure by supplying values of the monitored quantities exemplified above or supplying values of other physical quantities from which the software 1810, 1840 may compute or estimate the monitored quantities. The reconfiguring of the OTT connection 1816 may include message format, retransmission settings, preferred routing, etc.; the reconfiguring need not affect the base station 1818, and it may be unknown or imperceptible to the base station 1818. Such procedures and functionalities may be known and practiced in the art. In certain embodiments, measurements may involve proprietary UE signaling facilitating the host computer 1802's measurements of throughput, propagation times, latency, and the like. The measurements may be implemented in that the software 1810 and 1840 causes messages to be transmitted, in particular empty or ‘dummy’ messages, using the OTT connection 1816 while it monitors propagation times, errors, etc.

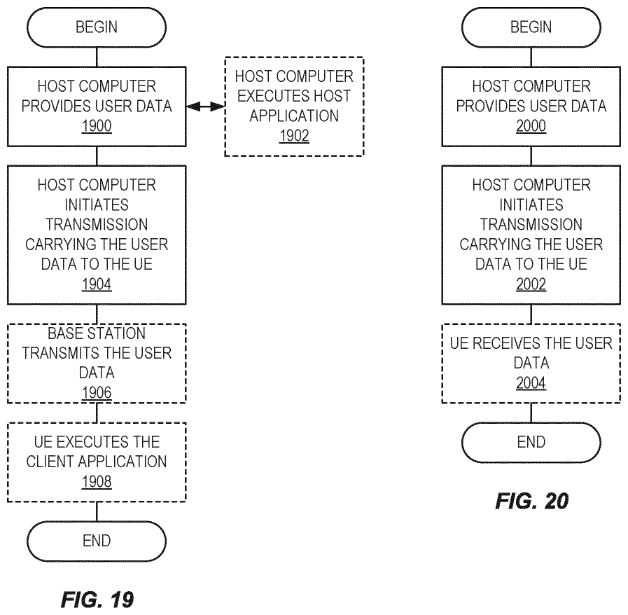

FIG. 19 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 19 will be included in this section. In step 1900, the host computer provides user data. In sub-step 1902 (which may be optional) of step 1900, the host computer provides the user data by executing a host application. In step 1904, the host computer initiates a transmission carrying the user data to the UE. In step 1906 (which may be optional), the base station transmits to the UE the user data which was carried in the transmission that the host computer initiated, in accordance with the teachings of the embodiments described throughout this disclosure. In step 1908 (which may also be optional), the UE executes a client application associated with the host application executed by the host computer.

FIG. 20 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 20 will be included in this section. In step 2000 of the method, the host computer provides user data. In an optional sub-step (not shown) the host computer provides the user data by executing a host application. In step 2002, the host computer initiates a transmission carrying the user data to the UE. The transmission may pass via the base station, in accordance with the teachings of the embodiments described throughout this disclosure. In step 2004 (which may be optional), the UE receives the user data carried in the transmission.

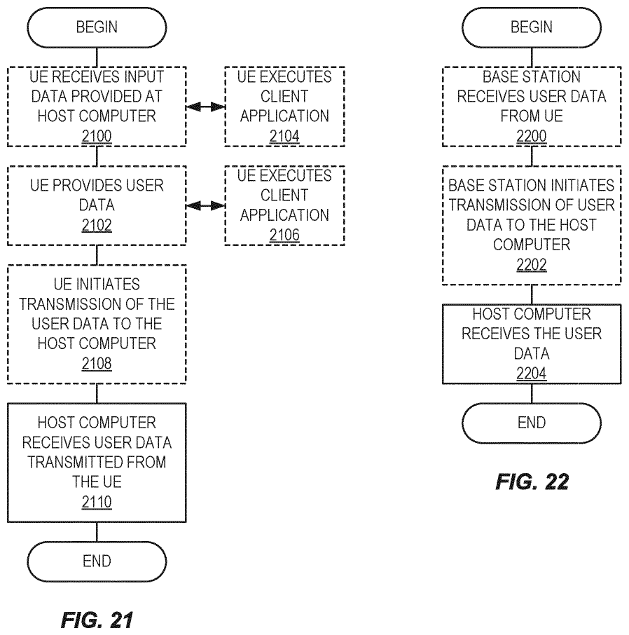

FIG. 21 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 21 will be included in this section. In step 2100 (which may be optional), the UE receives input data provided by the host computer. Additionally or alternatively, in step 2102, the UE provides user data. In sub-step 2104 (which may be optional) of step 2100, the UE provides the user data by executing a client application. In sub-step 2106 (which may be optional) of step 2102, the UE executes a client application which provides the user data in reaction to the received input data provided by the host computer. In providing the user data, the executed client application may further consider user input received from the user. Regardless of the specific manner in which the user data was provided, the UE initiates, in sub-step 2108 (which may be optional), transmission of the user data to the host computer. In step 2110 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 22 will be included in this section. In step 2200 (which may be optional), in accordance with the teachings of the embodiments described throughout this disclosure, the base station receives user data from the UE. In step 2202 (which may be optional), the base station initiates transmission of the received user data to the host computer. In step 2204 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

### Group A Embodiments

Embodiment 1: A method performed by a first network node, the method comprising one or more of: transmitting a FIRST MESSAGE towards a second network node, the FIRST MESSAGE comprising a model; and receiving a SECOND MESSAGE transmitted by the second network node, the SECOND MESSAGE comprising an indication that the second network node has re-trained or modified, the model transmitted by the first network node.

Embodiment 2: The method of embodiment 1 further comprising: transmitting within the FIRST MESSAGE or with a THIRD MESSAGE, further information associated to the model comprising one or more of: i.
an identity or an identifier of a model and/or an identifier of a specific version or vendor or type of the model to which the transmitted information is applicable to or associated to; ii. an indication that the model cannot be re-trained or modified; iii. an indication that the model can be re-trained or modified; and iv. an indication that model re-training or modification is suggested or recommended.

Embodiment 3: The method of any of embodiments 1-2 wherein the model is an Artificial Intelligence, AI, and/or Machine Learning, ML, model.

Embodiment 4: The method of any of embodiments 1-3 wherein the SECOND MESSAGE may provide a notification to the first network node that the second network node has re-trained or modified an AIML model provided by the first network node.

Embodiment 5: The method of any of embodiments 1-4 wherein the information provided with the FIRST MESSAGE or with a THIRD MESSAGE further includes an indication of at least one network node to which the provided indications are associated to.

Embodiment 6: The method of embodiment 5 wherein the at least one network node comprises the second network node or a third network node.

Embodiment 7: The method of any of embodiments 5-6 wherein the indication comprises an indication of at least a network node which could re-train or modify the model.

Embodiment 8: The method of any of embodiments 1-7 wherein, when the first network node indicates to the second network node that the model provided by the first network node can be re-trained or modified, the first network node further transmits to the second network node, either with the FIRST MESSAGE or with the THIRD MESSAGE, one or more information related to re-training or modifying the model, which may comprise one or more of: a. one or more conditions or events to be fulfilled for re-training the model; b. one or more instructions, policies and/or recommendations related to re-training the model; c. one or more instructions, policies and/or recommendations related to modifying the model; d. a request to transmit to the first network node an indication that the second network node has updated, re-trained and/or modified a model provided by the first network node; e.
one or more conditions and/or events to be fulfilled for transmitting to the first network node an indication that the second network node has updated, re-trained and/or modified a model provided by the first network node, such as changes in the environment where the model is applied (e.g., if the model is used for predictions of radio parameters/conditions, the event could consist of changes of the radio planning, changes of the radio conditions); f. one or more conditions related to use case(s) or time scale(s) for which re-training or modification of model is possible or suggested or recommended.

Embodiment 9: The method of any of embodiments 1-8 wherein the first network node further requests from the second network node, either within the FIRST MESSAGE, within the THIRD MESSAGE, or within another message information associated to the changes/modifications or updates done by the second network node to the model.

Embodiment 10: The method of any of embodiments 1-9 wherein the first network node comprises one or more of: an Operation and management (OAM) node; and a service and management orchestration (SMO) node, while the second network node comprises one or more of: a RAN node (such as NG-RAN node); a function of a RAN node (gNB, gNB-CU-CP, . . . ); a network node realizing at least in part a Non-Real Time Radio Intelligent Controller (Non-Real Time RIC); a network node realizing at least in part a Near-Real Time RIC; a Core Network node; and a Cloud-based centralized training node.

Embodiment 11: The method of any of embodiments 1 to 10, further comprising receiving either via the SECOND MESSAGE or via a FOURTH MESSAGE, a feedback report related to how a model provided by the first network node to the second network node has been re-trained or modified by the second network node.

Embodiment 12: The method of embodiment 11 wherein the feedback report comprises one or more information elements in the group of: a. one or more information related to at least a condition or event that triggered the re-training or the modification of the model (either at the second network node or in a third network node); b. one or more information related to how the model has been re-trained c. one or more information related to how the model has been modified d. information about the type of training data used, e.g., Data definition and semantics, range of training data values (e.g., Training data used within range [x, . . . ,y]), amount of data used (e.g., X million training data samples used for training), data used per data value range (e.g., X million training data samples within range [x, . . . ,y] used for training); e. instances of the outputs derived with the retrained/modified model and associated sample inputs; f. an indication that the model has been augmented or reduced; g.
an indication that the model has been modified and that the type of AIML model has been changed. For example, the indication could consist of different types of model types such as Linear Regression, Neural Network, Logistic Regression, Decision Trees, etc.; h. the retrained/modified model. Such retrained/modified model may be taken into account by the first network node for further development; i. an identity or an identifier of an AIML model to which the transmitted information is applicable to or associated to; j. an identifier of a specific version or vendor of the AIML model.

Embodiment 13: The method of any of embodiments 1-12, further comprising: providing user data; and forwarding the user data to a host computer via the transmission to the base station.

### Group B Embodiments

Embodiment 14: A method performed by a second network node, the method comprising one or more of: receiving a FIRST MESSAGE transmitted by the first network node, the FIRST MESSAGE comprising a model; and transmitting a SECOND MESSAGE towards the first network node comprising an indication that the second network node has re-trained or modified the model transmitted by the first network node.

Embodiment 15: The method of embodiment 14 further comprising: receiving, within the FIRST MESSAGE or with a THIRD MESSAGE, one or more information associated to the model indicating one or more of: i.
that the AIML model cannot be re-trained or modified; ii. that the AIML model can be re-trained or modified; and iii. that AIML model re-training or modification is suggested or recommended.

Embodiment 16: The method of any of embodiments 14-15 wherein the model is an Artificial Intelligence, AI, and/or Machine Learning, ML, model.

Embodiment 17: The method of any of embodiments 14-16, wherein the SECOND MESSAGE provides a notification to the first network node that the second network node has re-trained or modified a model provided by the first network node.

Embodiment 18: The method of any of embodiments 14 to 17, wherein the second network node may additionally transmit either via the SECOND MESSAGE or via a FOURTH MESSAGE, a feedback report related to how a model provided by the first network node to the second network node has been re-trained or modified by the second network node.

Embodiment 19: The method of embodiment 18 wherein the feedback report provided by the second network node in association to re-training or modifying an AIML model may comprise one or more information elements in the group of: a. one or more information related to at least a condition or event that triggered the re-training or the modification of the model (either at the second network node or in a third network node); b. one or more information related to how the model has been re-trained c. one or more information related to how the model has been modified d. information about the type of training data used, e.g., Data definition and semantics, range of training data values (e.g., Training data used within range [x, . . . ,y]), amount of data used (e.g., X million training data samples used for training), data used per data value range (e.g., X million training data samples within range [x, . . . ,y] used for training); e. instances of the outputs derived with the retrained/modified model and associated sample inputs; f. an indication that the model has been augmented or reduced; g. an indication that the model has been modified and that the type of AIML model has been changed. For example, the indication could consist of different types of model types such as Linear Regression, Neural Network, Logistic Regression, Decision Trees, etc.; h. the retrained/modified model. Such retrained/modified model may be taken into account by the first network node for further development; i. an identity or an identifier of an AIML model to which the transmitted information is applicable to or associated to; j. an identifier of a specific version or vendor of the AIML model.

Embodiment 20: The method of embodiment 19, wherein such indication related to augmentation, reduction or other modification of the model may either be provided as an enumerated field with values indicating “Augmented model” or “reduced model”, or may be a more detailed indication of how the model has been augmented/reduced (for example, in the case the model consists of a neural network, possible indications could be “Neural network augmented to X number of layers”, “Neural network reduced to X number of layers”).

Embodiment 21: The method of any of the embodiments 18-20, wherein the retrained/modified model may be considered by the first network node for comparison with the models trained by the first network node.

Embodiment 22: The method of any of embodiments 14-21 wherein the second network node may host several different models, wherein the different models may be transmitted by the first network node and/or derived by means of re-training/modification of models at the second network node.

Embodiment 23: The method of embodiment 22 wherein the second network node is able to choose which model to use to infer information regarding the use cases and conditions the second node needs to analyze.

Embodiment 24: The method of any of embodiments 14-23 wherein the first network node further requests either within the FIRST MESSAGE, within the THIRD MESSAGE, or within another message, information associated to the changes/modifications or updates done by the second network node to the model.

Embodiment 25: The method of any of embodiments 14-24 wherein the first network node comprises one or more of: an Operation and management (OAM) node; and a service and management orchestration (SMO) node, while the second network node comprises one or more of: a RAN node (such as NG-RAN node); a function of a RAN node (gNB, gNB-CU-CP, . . . ); a network node realizing at least in part a Non-Real Time Radio Intelligent Controller (Non-Real Time RIC); a network node realizing at least in part a Near-Real Time RIC; a Core Network node; and a Cloud-based centralized training node.

Embodiment 26: The method of any of embodiments 14-25, further comprising: obtaining user data; and forwarding the user data to a host computer or a wireless device.

### Group C Embodiments

Embodiment 27: A first network node, the first network node comprising: processing circuitry configured to perform any of the steps of any of the Group A embodiments; and power supply circuitry configured to supply power to the first network node.

Embodiment 28: A second network node, the second network node comprising: processing circuitry configured to perform any of the steps of any of the Group B embodiments; and power supply circuitry configured to supply power to the second network node.

Embodiment 29: A first network node, the first network node comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the first network node to be processed by the processing circuitry; an output interface connected to the processing circuitry and configured to output information from the first network node that has been processed by the processing circuitry; and a battery connected to the processing circuitry and configured to supply power to the first network node.

Embodiment 30: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group A or Group B embodiments.

Embodiment 31: The communication system of the previous embodiment further including the base station.

Embodiment 32: The communication system of the previous 2 embodiments, further including the UE, wherein the UE is configured to communicate with the base station.

Embodiment 33: The communication system of the previous 3 embodiments, wherein: the processing circuitry of the host computer is configured to execute a host application, thereby providing the user data; and the UE comprises processing circuitry configured to execute a client application associated with the host application.

Embodiment 34: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 35: The method of the previous embodiment, further comprising, at the base station, transmitting the user data.

Embodiment 36: The method of the previous 2 embodiments, wherein the user data is provided at the host computer by executing a host application, the method further comprising, at the UE, executing a client application associated with the host application.

Embodiment 37: A User Equipment, UE, configured to communicate with a base station, the UE comprising a radio interface and processing circuitry configured to perform the method of the previous 3 embodiments.

Embodiment 38: A communication system including a host computer comprising: processing circuitry configured to provide user data; and a communication interface configured to forward user data to a cellular network for transmission to a User Equipment, UE; wherein the UE comprises a radio interface and processing circuitry.

Embodiment 39: The communication system of the previous embodiment, wherein the cellular network further includes a base station configured to communicate with the UE.

Embodiment 40: The communication system of the previous 2 embodiments, wherein: the processing circuitry of the host computer is configured to execute a host application, thereby providing the user data; and the UE's processing circuitry is configured to execute a client application associated with the host application.

Embodiment 41: A method implemented in a communication system including a host computer, a base station, and a User Equipment, UE, the method comprising: at the host computer, providing user data; and at the host computer, initiating a transmission carrying the user data to the UE via a cellular network comprising the base station.

Embodiment 42: The method of the previous embodiment, further comprising at the UE, receiving the user data from the base station.

Embodiment 43: A communication system including a host computer comprising: communication interface configured to receive user data originating from a transmission from a User Equipment, UE, to a base station; wherein the UE comprises a radio interface and processing circuitry.

Embodiment 44: The communication system of the previous embodiment, further including the UE.

Embodiment 45: The communication system of the previous 2 embodiments, further including the base station, wherein the base station comprises a radio interface configured to communicate with the UE and a communication interface configured to forward to the host computer the user data carried by a transmission from the UE to the base station.

Embodiment 46: The communication system of the previous 3 embodiments, wherein: the processing circuitry of the host computer is configured to execute a host application; and the UE's processing circuitry is configured to execute a client application associated with the host application, thereby providing the user data.

Embodiment 47: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 48: A method implemented in a communication system including a host computer, a base station, and a User Equipment, UE, the method comprising: at the host computer, receiving user data transmitted to the base station from the UE.

Embodiment 49: The method of the previous embodiment, further comprising, at the UE, providing the user data to the base station.

Embodiment 50: The method of the previous 2 embodiments, further comprising: at the UE, executing a client application, thereby providing the user data to be transmitted; and at the host computer, executing a host application associated with the client application.

Embodiment 51: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 52: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 53: The communication system of the previous embodiment further including the base station.

Embodiment 54: The communication system of the previous 2 embodiments, further including the UE, wherein the UE is configured to communicate with the base station.

Embodiment 55: The communication system of the previous 3 embodiments, wherein: the processing circuitry of the host computer is configured to execute a host application; and the UE is configured to execute a client application associated with the host application, thereby providing the user data to be received by the host computer.

Embodiment 56: A method implemented in a communication system including a host computer, a base station, and a User Equipment, UE, the method comprising: at the host computer, receiving, from the base station, user data originating from a transmission which the base station has received from the UE.

Embodiment 57: The method of the previous embodiment, further comprising at the base station, receiving the user data from the UE.

Embodiment 58: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AI Artificial Intelligence
AIML Artificial Intelligence Machine Learning
AMF Access and Mobility Management Function
AN Access Network
ASIC Application Specific Integrated Circuit
AUSF Authentication Server Function
CP Control Plane
CPU Central Processing Unit
DCI Downlink Control Information
DN Data Network
DQN Deep Q-Network
DSP Digital Signal Processor
eNB Enhanced or Evolved Node B
EN-DC E-UTRAN New Radio Dual Connectivity
EPC Evolved Packet Core
E-UTRA Evolved Universal Terrestrial Radio Access
E-UTRAN Evolved Universal Terrestrial Radio Access Network
FFS For Further Study
FPGA Field Programmable Gate Array
gNB New Radio Base Station
gNB-CU New Radio Base Station Central Unit
gNB-CU-CP New Radio Base Station Central Unit Control Plane
gNB-DU New Radio Base Station Distributed Unit
HSS Home Subscriber Server
IAB Integrated Access and Backhaul
IoT Internet of Things
IP Internet Protocol
LTE Long Term Evolution
MAC Medium Access Control
ML Machine Learning
MME Mobility Management Entity
MR-DC Multi RAT Dual Connectivity
MTC Machine Type Communication
NEF Network Exposure Function
NF Network Function
NG Next Generation
NG-RANNext Generation Radio Access Network
NMS Network Management System
NR New Radio
NRF Network Function Repository Function
NSSF Network Slice Selection Function
OAM Operations, Administration, and Maintenance
O-CU Open Central Unit
O-CU-CP Open Central Unit Control Plane
O-DU Open Distributed Unit
ONAP Open Network Automation Platform
ONNX Open Neural Network eXchange
ORAN Open Radio Access Network
O-RU Open Radio Unit
OTT Over-the-Top
PC Personal Computer
PCF Policy Control Function
PDSCH Physical Downlink Shared Channel
P-GW Packet Data Network Gateway
PPO Proximal Policy Optimization
PRS Positioning Reference Signal
RAM Random Access Memory
RAN Radio Access Network
RAT Radio Access Technology
RELU Rectified Linear Unit
RIC Radio Intelligent Controller
ROM Read Only Memory
RP Reception Point
RRH Remote Radio Head
RT-RIC Real Time RAN Radio Intelligent Controller
RTT Round Trip Time
SCEF Service Capability Exposure Function
SI Study Item
SMF Session Management Function
SMO Service and Management Orchestration
TCI Transmission Configuration Indicator
TP Transmission Point
TR Technical Report
TRP Transmission/Reception Point
UDM Unified Data Management
UE User Equipment
UP User Plane
UPF User Plane Function

Those skilled in the art will recognize improvements and modifications to the embodiments of the present disclosure. All such improvements and modifications are considered within the scope of the concepts disclosed herein.

1. A method performed by a first network node, the method comprising:
transmitting a FIRST MESSAGE towards a second network node, the FIRST MESSAGE comprising a model;
receiving a SECOND MESSAGE transmitted by the second network node, the SECOND MESSAGE comprising an indication that the second network node has re-trained or modified the model transmitted by the first network node; and
receiving either via the SECOND MESSAGE or via a FOURTH MESSAGE, a feedback reporting related to how the model provided by the first network node to the second network node has been retrained or modified by the second network node, wherein the feedback report comprises one or more information related to at least a condition or event that triggered the re-training or the modification of the model.

2. The method of claim 1 further comprising:
transmitting within the FIRST MESSAGE or with a THIRD MESSAGE, further information associated to the model comprising one or more of:
an identity or an identifier of the model and/or an identifier of a specific version or vendor or type of the model to which the transmitted information is applicable to or associated to;
an indication that the model cannot be re-trained or modified;
an indication that the model can be re-trained or modified; and
an indication that model re-training or modification is suggested or recommended.

3. The method of claim 1 wherein the model is an Artificial Intelligence, AI, and/or Machine Learning, ML, model.

4. The method of claim 1 wherein the SECOND MESSAGE provides a notification to the first network node that the second network node has re-trained or modified an AIML model provided by the first network node.

5. The method of claim 1 wherein the information provided with the FIRST MESSAGE or with the THIRD MESSAGE further includes an indication of at least one network node to which the provided indications are associated.

6. The method of claim 5 wherein the at least one network node comprises the second network node or a third network node.

7. The method of claim 5 wherein the indication comprises an indication of at least a network node which could re-train or modify the model.

8. The method of claim 1 wherein, when the first network node indicates to the second network node that the model provided by the first network node can be re-trained or modified, the first network node further transmits to the second network node, either with the FIRST MESSAGE or with the THIRD MESSAGE, one or more information related to re-training or modifying the model, which may comprise one or more of:
one or more conditions or events to be fulfilled for re-training the model;
one or more instructions, policies and/or recommendations related to re-training the model;
one or more instructions, policies and/or recommendations related to modifying the model;
a request to transmit to the first network node an indication that the second network node has updated, re-trained and/or modified the model provided by the first network node;
one or more conditions and/or events to be fulfilled for transmitting to the first network node an indication that the second network node has updated, re-trained and/or modified a model provided by the first network node, such as changes in the environment where the model is applied;
one or more conditions related to use case(s) or time scale(s) for which re-training or modification of the model is possible or suggested or recommended.

9. The method of claim 1 wherein the first network node further requests from the second network node, either within the FIRST MESSAGE, within the THIRD MESSAGE, or within another message information associated to the changes/modifications or updates done by the second network node to the model.

10. The method of claim 1 wherein the first network node comprises one or more of: an Operation and Management, OAM, node; and a Service and Management Orchestration, SMO, node, while the second network node comprises one or more of: a Radio Access Network, RAN, node; a Next Generation Radio Access Network, NG-RAN, node; a function of a RAN node; a New Radio Base Station, gNB; a gNB-Control Unit-Control Plane, gNB-CU-CP; a network node realizing at least in part a Non-Real Time Radio Intelligent Controller, RIC; a network node realizing at least in part a Near-Real Time RIC; a Core Network node; and a Cloud-based centralized training node.

11. (canceled)

12. The method of claim 1 wherein the feedback report comprises one or more information elements in the group of:
one or more information related to how the model has been re-trained;
one or more information related to how the model has been modified;
information about the type of training data used;
instances of outputs derived with the retrained/modified model and associated sample inputs;
an indication that the model has been augmented or reduced;
an indication that the model has been modified and that the type of AIML model has been changed;
the retrained/modified model;
an identity or an identifier of an AIML model to which the transmitted information is applicable or associated; and
an identifier of a specific version or vendor of the AIML model.

13. A method performed by a second network node, the method comprising:
receiving a FIRST MESSAGE from a second network node, the FIRST MESSAGE comprising a model;
transmitting a SECOND MESSAGE towards the second network node, the SECOND MESSAGE comprising an indication that the second network node has re-trained or modified the model transmitted by the first network node; and
transmitting either via the SECOND MESSAGE or via a FOURTH MESSAGE, a feedback reporting related to how the model provided by the first network node to the second network node has been retrained or modified by the second network node, wherein the feedback report comprises one or more information related to at least a condition or event that triggered the re-training or the modification of the model.

14. (canceled)

15. A first network node for managing models comprising processing circuitry configured to cause the first network node to:
transmit, towards a second network node, a FIRST MESSAGE, the FIRST MESSAGE comprising a model; and
receive a SECOND MESSAGE transmitted by the second network node, the SECOND MESSAGE comprising an indication that the second network node has re-trained or modified the model transmitted by the first network node.

16. (canceled)

17. A second network node for managing models comprising processing circuitry configured to cause the second network node to:
receive a FIRST MESSAGE from a second network node, the FIRST MESSAGE comprising a model; and
transmit a SECOND MESSAGE towards the second network node, the SECOND MESSAGE comprising an indication that the second network node has re-trained or modified the model transmitted by the first network node.

18. (canceled)
